(19) United States
(12) Patent Application Publication
(10) Pub. No.: US 2026/0299396 A1
(43) Pub. Date: Oct. 1, 2026

(54) FOLDABLE ELECTRONIC DEVICE INCLUDING CAMERA MODULE

(71) Applicant: Samsung Electronics Co., Ltd., Suwon-si (KR)

(72) Inventors: Doyun KIM, Suwon-si (KR); Eunsoo PARK, Suwon-si (KR); Dongwoo LEE, Suwon-si (KR)

(21) Appl. No.: 19/289,755

(22) Filed: Aug. 4, 2025

Related U.S. Application Data
(63) Continuation of application No. PCT/KR2025/011112, filed on Jul. 25, 2025.

(30) Foreign Application Priority Data
Mar. 31, 2025 (KR) 10-2025-0041105
May 2, 2025 (KR) 10-2025-0058167

(51) Int. Cl. G03B 30/00; G03B 15/03; G06F 1/16

(52) U.S. Cl. CPC G03B 30/00; G03B 15/03; G06F 1/1641; G06F 1/1652; G06F 1/1686

(57) ABSTRACT

According to an embodiment, an electronic device may comprise: a housing forming an exterior of the electronic device, a camera module at least partially disposed inside the housing, the camera module comprising a camera bracket, at least one lens accommodated in the camera bracket, and a camera cover covering the camera bracket, and a light-emitting module disposed around the camera module, the light-emitting module comprising a light-emitting module bracket and a light-emitting diode (LED) disposed in the light-emitting module bracket. The camera cover may include a first protrusion protruding in a first direction toward an outside from one surface of the housing and a second protrusion and spaced apart from the first protrusion and protruding in a second direction opposite to the first direction. The second protrusion may at least partially surround the light-emitting diode.

### CROSS-REFERENCE TO RELATED APPLICATIONS

This application is a continuation of International Application No. PCT/KR2025/011112 designating the United States, filed on Jul. 25, 2025, in the Korean Intellectual Property Receiving Office and claiming priority to Korean Patent Application Nos. 10-2025-0041105, filed on May 31, 2025, and 10-2025-0058167, filed on May 2, 2025, in the Korean Intellectual Property Office, the disclosures of each of which are incorporated by reference herein in their entireties.

### BACKGROUND

### Field

The disclosure relates to a foldable electronic device, e.g., a foldable electronic device including a camera module.

### Description of the Related Art

Advancing information communication technologies and semiconductor technologies accelerate the spread and use of various electronic devices. In particular, recent electronic devices are being developed to carry out communication while carried on.

The term "electronic device" may refer, for example, to a device performing a particular function according to its equipped program, such as a home appliance, an electronic scheduler, a portable multimedia player, a mobile communication terminal, a tablet PC, a video/sound device, a desktop PC or laptop computer, a navigation for automobile, etc. For example, the electronic devices may output stored information as voices or images. As electronic devices are highly integrated, and high-speed, high-volume wireless communication becomes commonplace, an electronic device, such as a mobile communication terminal, is recently being equipped with various functions. For example, an electronic device comes with the integrated functionality, including an entertainment function, such as playing video games, a multimedia function, such as replaying music/videos, a communication and security function for mobile banking, and a scheduling and e-wallet function.

As smartphones or other personal/portable communication devices spread, users' demand for portability and use convenience is on the rise. For example, a touchscreen display may not only serve as an output device of visual information but also provide a virtual keyboard that replaces a mechanical input device (e.g., a button input device). As such, portable communication devices or electronic devices may be made compact while delivering further enhanced applicability (e.g., a larger screen). Flexible displays, e.g., foldable displays, will come in commerce and electronic devices are expected to deliver better portability and use convenience. Such a foldable electronic device may be carried with a plurality of different structures (e.g., housings) folded and may provide a larger screen in the unfolded state, thereby providing enhanced portability and ease of use.

The electronic device may include a camera module and a light-emitting module to support a capturing function. The light-emitting module may brightly illuminate a subject when a consumer takes photographs in low-light conditions, functioning similarly to the flash of a conventional camera. To this end, a light-emitting diode is designed to be disposed in a specific structure to provide optimal lighting.

In the electronic device, a light-emitting diode lens is configured integrally with the substrate of the light-emitting module, and may be disposed near the camera module. However, in this structure, the light from the light-emitting diode may be introduced into the camera module, causing noise (e.g., light leakage) in the captured result. To avoid this, a partition wall structure may be installed between the camera module and the light-emitting module to block the inflow of unnecessary light.

The above-described information may be provided as related art for the purpose of helping understanding of the disclosure. No assertion or determination is made as to whether any of the foregoing is applicable as background art in relation to the disclosure.

### SUMMARY

Embodiments of the disclosure relate to an electronic device. According to an example embodiment of the disclosure, an electronic device may comprise: a housing forming an exterior of the electronic device, a camera module at least partially disposed inside the housing, the camera module comprising a camera bracket, at least one lens accommodated in the camera bracket, and a camera cover covering the camera bracket, and a light-emitting module disposed around the camera module, the light-emitting module comprising a light-emitting module bracket and a light-emitting diode (LED) disposed in the light-emitting module bracket, wherein the camera cover may include a first protrusion protruding in a first direction toward an outside from one surface of the housing and a second protrusion spaced apart from the first protrusion and protruding in a second direction opposite to the first direction, and the second protrusion may at least partially surround the light-emitting diode.

Embodiments of the disclosure relate to a foldable electronic device. According to an example embodiment of the disclosure, a foldable electronic device may Bcomprise: a foldable housing including a first housing and a second housing rotatably disposed relative to the first housing, a hinge structure including a hinge connected to the first housing and the second housing, a sub display disposed in the first housing and facing the first direction, a flexible display disposed in the foldable housing and facing a second direction opposite to a first direction, a light-emitting module at least partially disposed in the second direction of the sub display, including a light-emitting module bracket and a light-emitting diode (LED) disposed in the first direction of the light-emitting module bracket, wherein the light-emitting diode may be disposed to face the first direction and may be configured to emit light to an outside of the foldable electronic device, and a camera module at least partially disposed in the second direction of the sub display and disposed adjacent to the light-emitting module in a third direction perpendicular to the first direction, and including a camera bracket, one or more lenses at least partially accommodated in the camera bracket, and a camera cover at least partially disposed in the second direction of the sub display and disposed in the first direction of the camera bracket, wherein the camera cover may include a second protrusion protruding toward the light-emitting module bracket in the second direction.

### BRIEF DESCRIPTION OF THE DRAWINGS

The foregoing and other aspects, features, and/or advantages of an embodiment of the disclosure will be more apparent from the following detailed description taken in conjunction with the accompanying drawings, in which:

FIG. 1 is a block diagram illustrating an example electronic device in a network environment according to various embodiments;

FIG. 2 is a diagram illustrating a front view, side view, and rear view of an electronic device in an unfolded state according to various embodiments;

FIG. 3 is a diagram illustrating a front view, side view, and rear view of an electronic device in a folded state according to various embodiments;

FIG. 4 is an exploded perspective view illustrating an electronic device according to various embodiments;

FIGS. 5A and 5B are a cross-sectional views illustrating a portion of an electronic device according to various embodiments;

FIGS. 6A and 6B include a plan view and perspective view illustrating a portion of an electronic device according to various embodiments;

FIGS. 7A and 7B are diagrams illustrating plan views of a portion of an electronic device according to various embodiments;

FIG. 8 is a cross-sectional view illustrating a camera module, a light-emitting module, and a display panel of an electronic device according to various embodiments;

FIG. 9 is a cross-sectional view illustrating a camera module, a light-emitting module, and a display panel of an electronic device according to an various embodiments;

FIGS. 10A and 10B are plan views illustrating a portion of an electronic device according to various embodiments;

FIG. 11 is a perspective view illustrating a portion of an electronic device according to various embodiments;

FIG. 12 is a cross-sectional view illustrating a camera module, a light-emitting module, and a display panel of an electronic device according to various embodiments;

FIG. 13 is a perspective view illustrating a portion of an electronic device according to various embodiments;

FIG. 14 is a cross-sectional view illustrating a camera module, a light-emitting module, and a display panel of an electronic device according to various embodiments;

FIG. 15 is a cross-sectional view illustrating a camera module, a light-emitting module, and a display panel of an electronic device according to various embodiments;

FIG. 16 is a cross-sectional view illustrating a camera module, a light-emitting module, and a display panel of an electronic device according to various embodiments; and

FIG. 17 is a perspective view illustrating a camera cover (camera cover) of an electronic device according to various embodiments.

Throughout the drawings, like reference numerals may be assigned to like parts, components, and/or structures.

### DETAILED DESCRIPTION

As the demand for the reduction in weight and slimming of electronic devices continues, the optimization of space for internal components is essential, and a camera module and a light-emitting module may also be constrained by the mounting space.

For example, a partition wall structure may be applied to prevent/reduce the light emitted from the light-emitting module from being transferred to the camera module, but due to space constraints, some light may still be introduced into the camera module. Accordingly, if the light emitted from the light-emitting diode is transferred to the camera module, there is a possibility of light spreading (optical noise) in the captured image, and to prevent or avoid this, an enhanced partition wall structure capable of space-efficient and effective light blocking is required.

Additionally, in foldable electronic devices, the available mounting space in the height direction (e.g., the Z-axis direction) is limited. Therefore, a strategy to maximize/increase space efficiency may be considered when designing a new partition wall structure. Moreover, important design considerations include the issues of heat generation resulting from the continuous operation of the light-emitting module and the potential durability concerns that may arise from the mounting of the display panel. Accordingly, there is a need for structural enhancement that may effectively block noise, such as light leakage, that may occur in the captured result while adhering to these various restrictions.

According to an example embodiment of the disclosure, there may be provided an electronic device that may efficiently utilize the mounting space in the height direction (e.g., the Z-axis direction) of the foldable electronic device while effectively preventing/reducing noise (e.g., light leakage) that may occur in the captured result by forming a partition wall structure in which at least a portion of the camera cover included in the camera module protrudes toward the flash module.

Aspects of the disclosure are not limited to the foregoing, and other unmentioned objects would be apparent to one of ordinary skill in the art from the following description.

The following description taken in conjunction with the accompanying drawings may provide an understanding of various example implementations of the disclosure, including claims and their equivalents. The various example embodiments disclosed in the following description entail various details to aid understanding, but are regarded as one of various example embodiments. Accordingly, it will be understood by those skilled in the art that various changes and modifications may be made to the various implementations described in the disclosure without departing from the scope and spirit of the disclosure. Further, descriptions of well-known functions and configurations may be omitted for clarity and brevity.

The terms and words used in the following description and claims are not limited to the bibliographical meaning, but may be used to clearly and consistently describe an embodiment of the disclosure. Therefore, it will be apparent to those skilled in the art that the following description of various implementations of the disclosure is provided only for the purpose of description, not for the purpose of limiting the disclosure defined as the scope of the claims and equivalent thereto.

The singular forms “a,” “an,” and “the” are intended to include the plural forms as well, unless the context clearly indicates otherwise. Thus, as an example, “a component surface” may be interpreted as including one or more of the surfaces of a component.

In the following detailed description, a length direction, a width direction, and/or a thickness direction (or height direction) of the electronic device may be mentioned and may be defined as a ‘Y-axis direction,’ ‘X-axis direction’, and/or ‘Z-axis direction,’ respectively. In an embodiment, 'negative/positive (-/+)' may be mentioned together with the Cartesian coordinate system illustrated in the drawings with respect to the direction in which the component is oriented. For example, the front surface of the electronic device and/or housing may be defined as a 'surface facing in the +Z direction,' and the rear surface may be defined as a 'surface facing in the -Z direction'. In an embodiment, the side surface of the electronic device and/or housing may include an area facing in the +X direction, an area facing in the +Y direction, an area facing in the -X direction, and/or an area facing in the -Y direction. In an embodiment, the 'X-axis direction' may refer, for example, to including both the '-X direction' and the '+X direction'.

Hereinafter, in the description of the electronic device 101 described below, the ‘first direction’ may refer, for example, to the -Z-axis direction (or a direction parallel to the -Z-axis), the ‘second direction’ may refer, for example, to the +Z-axis direction (or a direction parallel to the +Z-axis), and the ‘third direction’ may refer, for example, to the Y-axis direction (or a direction parallel to the Y-axis).

Hereinafter, in the description of the electronic device 101, when a component is 'disposed on' another component, it may refer, for example, to the component being disposed in the +Z direction with respect to the other component. It should be noted that the directions are so defined with respect to the Cartesian coordinate system shown in the drawings for the sake of brevity of description, and the description of these directions or components do not limit an embodiment(s) of the disclosure. For example, the Cartesian coordinate system may be defined as different from that disclosed in the disclosure depending on the specifications of the electronic device or the user’s usage habits.

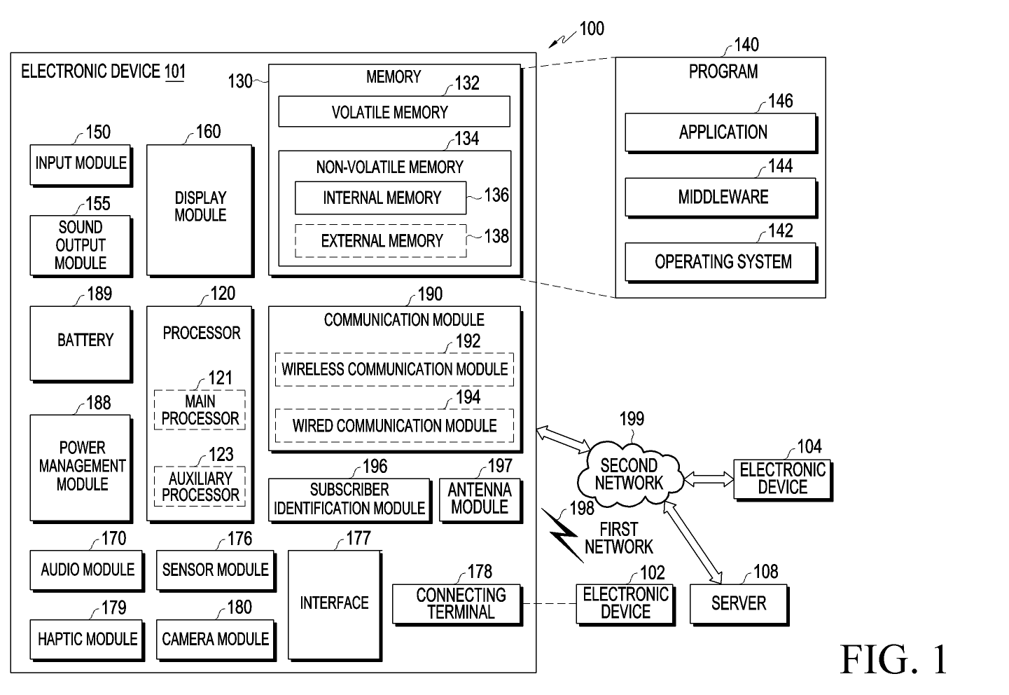

FIG. 1 is a block diagram illustrating an example electronic device 101 in a network environment 100 according to various embodiments.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited /disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth^{TM}, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20Gbps or more) for implementing eMBB, loss coverage (e.g., 164dB or less) for implementing mMTC, or U-plane latency (e.g., 0.5ms or less for each of downlink (DL) and uplink (UL), or a round trip of 1ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to an embodiment of the disclosure may be one of various types of devices. The electronic devices may include, for example, a portable communication device (e.g., a smartphone), a computer device, a portable multimedia device, a portable medical device, a camera, a wearable device, a home appliance, or the like. The electronic devices according to an embodiment are not limited to those described above.

It should be appreciated that various example embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as "A or B," "at least one of A and B," “at least one of A or B,” "A, B, or C," "at least one of A, B, and C," and “at least one of A, B, or C,” may include all possible combinations of the items enumerated together in a corresponding one of the phrases. As used herein, such terms as "1st" and "2nd," or “first” and "second" may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” "coupled to," "connected with," or “connected to” another element (e.g., a second element), the element may be coupled with the other element directly (e.g., wiredly), wirelessly, or via a third element.

As used herein, the term "module" may include a unit implemented in hardware, software, or firmware, or any combination thereof, and may interchangeably be used with other terms, for example, "logic," "logic block," "part," or "circuitry". A module may be a single integral component, or a minimum unit or part thereof, adapted to perform one or more functions. For example, according to an embodiment, the module may be implemented in a form of an application-specific integrated circuit (ASIC).

An embodiment of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term "non-transitory" simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store^{TM}), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

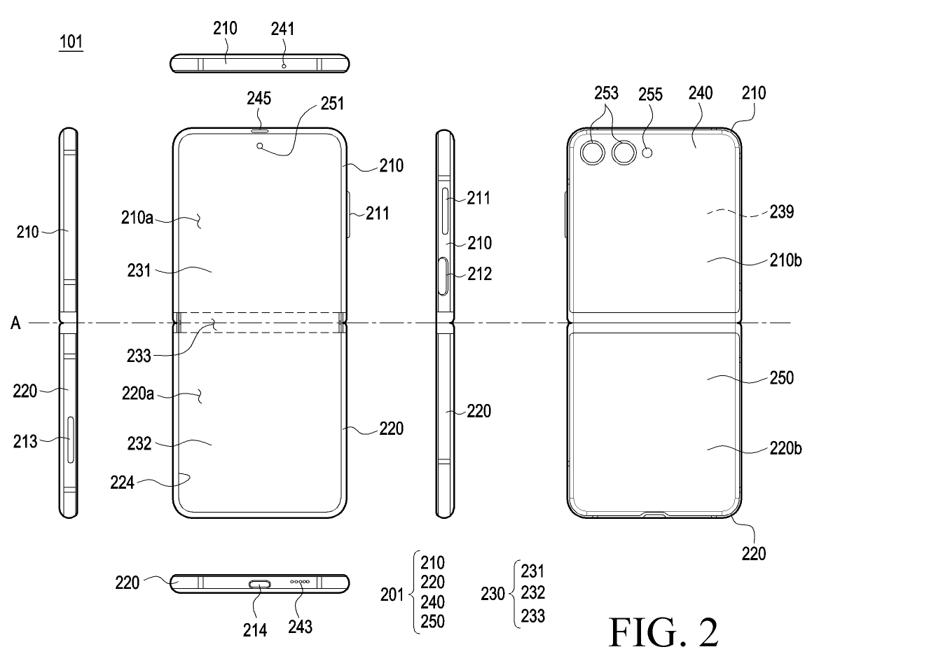

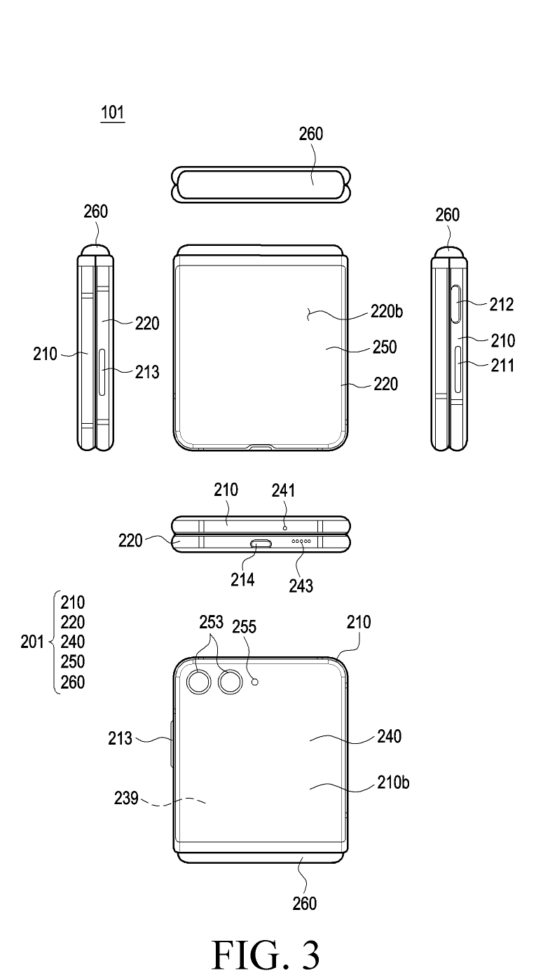

FIG. 2 is a diagram illustrating a front view, side view, and rear view illustrating an electronic device in an unfolded state according to various embodiments. FIG. 3 is a diagram illustrating a front view, side view, and rear view illustrating an electronic device in a folded state according to various embodiments.

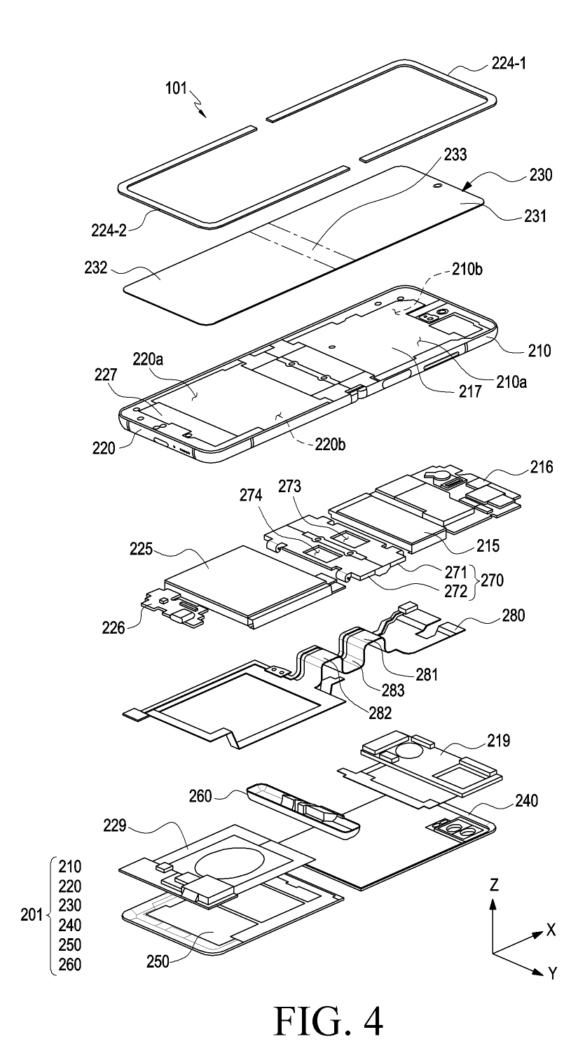

The example embodiments of FIGS. 2 and 3 may be combined with the example embodiment of FIG. 1 or the example embodiments of FIGS. 4-17.

The configurations of the example embodiments of FIGS. 2 and 3 may be identical in whole or part to the configurations of the example embodiment of FIG. 1, or the configurations of the example embodiments of FIGS. 4-17.

Referring to FIGS. 2 and 3, an electronic device 101 (e.g., the electronic device 101 of FIG. 1 ) according to an embodiment may include a foldable housing 201 and a flexible display 230 (e.g., the display module 160 of FIG. 1 ) disposed on the foldable housing 201. The electronic device 101 may be defined and/or referred to as a foldable electronic device. The flexible display 230 may be defined and/or referred to as a foldable display.

According to an embodiment, the foldable housing 201 may be at least partially folded or unfolded.

According to an embodiment, the foldable housing 201 may include a first housing 210, a second housing 220, and a hinge cover 260 (e.g., the hinge cover 260 of FIG. 3).

According to an embodiment, the first housing 210 may include a first rear cover 240, and the second housing 220 may include a second rear cover 250.

According to an embodiment, the surface on which the flexible display 230 is disposed may be defined as a front surface of the electronic device 101. At least a portion of the front surface of the electronic device 101 may be formed of a substantially transparent front plate (e.g., a glass plate or polymer plate including various coat layers). The opposite surface of the front surface may be defined as a rear surface of the electronic device 101. The rear surface of the electronic device 101 may be formed by a substantially opaque rear plate (hereinafter, referred to as a 'back cover'). The back cover may be formed of, e.g., laminated or colored glass, ceramic, polymer, metal (e.g., aluminum, stainless steel (STS), or magnesium), or a combination of at least two thereof. The surface surrounding the space between the front and back surfaces may be defined as a side surface of the electronic device 101. The side surface of the electronic device 101 may be formed by a side bezel structure (or a "side member") that couples to the front plate and the rear plate and includes a metal and/or polymer. According to an embodiment, the back cover and the side bezel plate may be integrally formed together and include the same material (e.g., a metal, such as aluminum).

According to an embodiment, the electronic device 101 may include at least one or more of a flexible display 230, audio modules 241, 243, and 245, a sensor module, a light-emitting module 255, camera modules 251 and 253, key input devices 211, 212, and 213, and a connector hole 214. According to an embodiment, the electronic device 101 may omit at least one (e.g., the key input devices 211, 212, and 213) of the components or additionally include another component (e.g., a light emitting device).

According to an embodiment, the flexible display 230 may include a display in which at least a partial area of the flexible display 230 may be transformed into a flat or curved surface.

According to an embodiment, the flexible display 230 may include a folding area 233, a first area 231 disposed on one side of the folding area 233 (e.g., the upper side of the folding area 233 of FIG. 2), and a second area 232 disposed on the opposite side of the folding area 233 (e.g., the lower side of the folding area 203 of FIG. 2). However, the segmentation of the flexible display 230 as shown in FIG. 2 is merely an example, and the flexible display 230 may be divided into a plurality of (e.g., four or more, or two) areas depending on the structure or function of the display 200. For example, in the example embodiment illustrated in FIG. 2, the flexible display 230 may be divided into the areas by the folding area 233 or folding axis A but, in an embodiment, the flexible display 230 may be divided into the areas with respect to another folding area or another folding axis (e.g., a folding axis perpendicular to the folding axis A).

According to an embodiment, a microphone 241 for obtaining an external sound may be disposed inside the microphone hole. In an embodiment, a plurality of microphones may be positioned to detect the direction of sound.

According to an embodiment, the speaker holes 243 and 245 may include an external speaker hole 243 and a phone receiver hole 245. In an embodiment, the speaker holes 243 and 245 and the microphone hole 241 may be implemented as a single hole, or speakers may be rested without the speaker holes 243 and 245 (e.g., piezo speakers). Various changes may be made to the position and number of microphone holes 241 and speaker holes 243 and 245 according to an embodiment.

According to an embodiment, the camera modules 251 and 253 may include a first camera device 251 disposed on the first surface 210a (e.g., the front surface of the first housing 210) of the first housing 210 of the electronic device 101 and a second camera device 253 disposed on the second surface 210b (e.g., the rear surface of the first housing 210) of the first housing 210.

The electronic device 101 may further include a light-emitting module 255. The camera devices 251 and 253 may include one or more lenses, an image sensor, and/or an image signal processor. The light-emitting module 255 may include, e.g., a light emitting diode (LED) or a xenon lamp.

According to an embodiment, the sensor module (not illustrated) may generate an electrical signal or a data value corresponding to an internal operating state of the electronic device 101 or an external environmental state. Although not illustrated, the electronic device 101 may additionally or alternatively include a sensor module (e.g., the sensor module 176 of FIG. 1) other than the sensor module (not illustrated) provided on the second surface 210b of the first housing 210. The electronic device 101 may include, as the sensor module, at least one of a proximity sensor, a fingerprint sensor, an HRM sensor, a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, or an illuminance sensor.

According to an embodiment, the key input devices 211, 212, and 213 may be disposed on a side surface (e.g., the side surface of the first housing 210 or the side surface of the second housing 220) of the foldable housing 201. According to an embodiment, the electronic device 101 may exclude all or some of the above-mentioned key input devices 211, 212, and 213 and the excluded key input devices may be implemented in the form of soft keys, on the flexible display 230. In an embodiment, the key input device may be configured to implement key input by a sensor module (e.g., a gesture sensor).

According to an embodiment, the connector hole 214 may be configured to receive a connector (e.g., a USB connector) for transmitting/receiving power and/or data to/from an external electronic device or, additionally or alternatively, a connector for transmitting/receiving audio signals to/from an external electronic device.

According to an embodiment, the foldable housing 201 may include a first housing 210, a second housing 220, and a hinge cover 260.

According to an embodiment, the first housing 210 may include a first rear cover 240, and the second housing 220 may include a second rear cover 250. The hinge cover 260 may cover the hinge module or the hinge structure (e.g., the hinge structure 270 of FIG. 4).

An example is described in which the first rear cover 240 is included in the first housing 210, and the second rear cover 250 is included in the second housing 220, but the disclosure is not limited thereto. For example, the first rear cover 240 may be a separate component coupled to the first housing 210, and the second rear cover 250 may be a separate component coupled to the second housing 220.

According to an embodiment, the foldable housing 201 may be at least partially folded or unfolded. For example, the foldable structure of the foldable housing 201 may be implemented by the coupling of the first housing 210, the second housing 220, and/or the hinge structure (e.g., the hinge structure 270 of FIG. 4).

According to an embodiment, the foldable housing 201 of the electronic device 101 are not limited to the shape and coupling shown in FIG. 2 but may rather be implemented in other shapes or via a combination and/or coupling of other components. For example, in an embodiment, the first housing 210 and the first back cover 240 may be integrally formed with each other, and the second housing 220 and the second back cover 250 may be integrally formed with each other. According to an embodiment, ‘housing’ may refer, for example, to a combination of other various components not mentioned and/or a combined configuration thereof. For example, it may be described that a first area 231 of the flexible display 230 forms one surface of the first housing 210 and, in an embodiment, the first area 231 of the flexible display 230 is disposed or attached to one surface of the first housing 210.

According to an embodiment, the first housing 210 may be connected to the hinge structure (e.g., the hinge structure 270 of FIG. 4) and may include a first surface 210a facing a first direction and a second surface 210b facing a second direction opposite to the first direction. The second housing 220 may be connected to a hinge structure (e.g., the hinge structure 270 of FIG. 4) and may include a third surface 220a facing a third direction and a fourth surface 220b facing a fourth direction opposite to the third direction. According to an embodiment, the second housing 220 may rotate or pivot relative to the first housing 210 about the folding axis A provided by the hinge structure (e.g., the hinge structure 270 of FIG. 4).

According to an embodiment, the first housing 210 and the second housing 220 may be disposed on two opposite sides (or upper/lower sides) of the folding axis A. The angle or distance between the first housing 210 and the second housing 220 may be varied depending on whether the electronic device 101 is in the unfolded state (e.g., FIG. 2), the folded state (e.g., FIG. 3), or the partially unfolded (or partially folded) intermediate state.

According to an embodiment, at least a portion of the first housing 210 and the second housing 220 may be formed of a metallic material or a non-metallic material having rigidity of a selected size for supporting the flexible display 230. The at least a portion formed of the metal material may be provided as a ground plane or radiating conductor of the electronic device 101 and, if provided as the ground plane, it may be electrically connected with a ground line formed on the printed circuit board (e.g., the printed circuit board 216 or 226 of FIG. 4).

According to an embodiment, the first rear cover 240 may be disposed on the rear surface of the electronic device 101 (e.g., the rear surface 210b of the first housing 210). For example, the first rear cover 240 may be disposed on one side of the folding axis A and may have, e.g., a substantially rectangular periphery which may be surrounded by the side bezel structure. Similarly, the second rear cover 250 may be disposed on the other side of the folding axis A on the rear surface of the electronic device 101 (e.g., the rear surface 220b of the second housing 220) and its periphery may be surrounded by the side bezel structure.

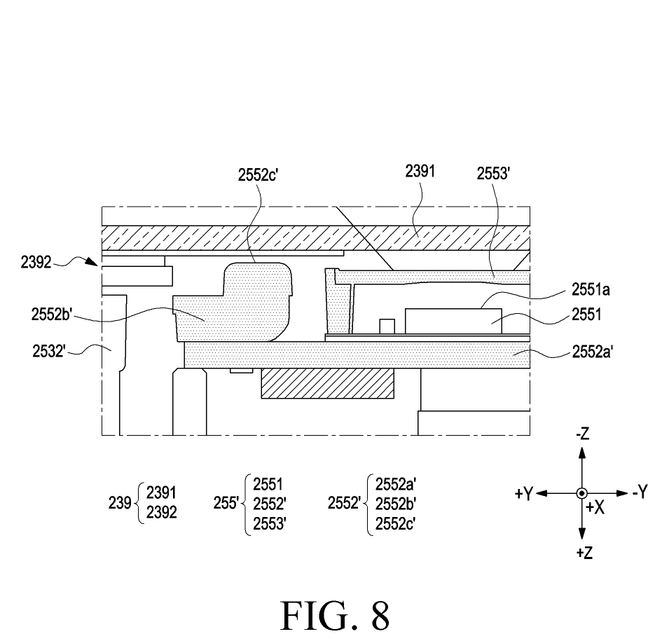

According to an embodiment, the first rear cover 240 and the second rear cover 250 may be substantially symmetrical in shape with respect to the folding axis A. However, the first rear cover 240 and the second rear cover 250 are not necessarily symmetrical in shape. In an embodiment, the electronic device 101 may include the first rear cover 240 and the second rear cover 250 in various shapes. In an embodiment, the first back cover 240 may be integrally formed with the first housing 210, and the second back cover 250 may be integrally formed with the second housing 220. According to an embodiment, the first rear cover 240 may include a window (e.g., the window 2391 of FIG. 8).

According to an embodiment, the first housing 210 and the second housing 220 may form a space where various components (e.g., the printed circuit boards 216 and 226 or batteries 215 and 225 of FIG. 4) of the electronic device 101 may be disposed. According to an embodiment, one or more components may be arranged or visually exposed on/through the rear surface of the electronic device 101. For example, at least a portion of a sub display 239 may be visible through the first rear cover 240. In an embodiment, one or more components or sensors may be visually exposed through the first back cover 240. According to an embodiment, the components or sensors may include a proximity sensor, a rear camera, and/or a flash. Although not separately shown in the drawings, one or more other components or sensors may be visually exposed through the second back cover 250.

According to an embodiment, the front camera device 251 exposed from the front surface of the electronic device 101 through one or more openings or the rear camera 253 exposed through the first rear cover 240 may include one or more lenses, an image sensor, and/or an image signal processor. The flash (not shown) may include, e.g., a light emitting diode or a xenon lamp. In an embodiment, two or more lenses (infrared cameras, wide-angle and telephoto lenses) and image sensors may be disposed on one surface of the electronic device 101.

According to an embodiment, the first housing 210 and the second housing 220 may rotate through a hinge structure (e.g., the hinge structure 270 of FIG. 4). When the electronic device 101 changes from the unfolded state to the folded state (e.g., changing from FIGS. 2-3), the first housing 210 and the second housing 220 can rotate about the hinge structure 270 so that the front surface of the first housing 210 and the front surface of the second housing 220 approach or face each other. When the electronic device 101 switches from the folded state to the unfolded state (e.g., changing from FIGS. 3-2), the first housing 210 and the second housing 220 may rotate about the hinge structure (e.g., the hinge structure 270 of FIG. 4) so that the front surface of the first housing 210 and the front surface of the second housing 220 face substantially the same direction.

According to an embodiment, the folding direction of the first housing 210 and/or the second housing 220 may include a direction in which the first housing 210 and/or the second housing 220 is rotated about the hinge structure 270 when the first housing 210 and/or the second housing 220 switches from the unfolded state to the folded state. The unfolding direction of the first housing 210 and/or the second housing 220 may include a direction in which the first housing 210 and/or the second housing 220 is rotated about the hinge structure 270 when the first housing 210 and/or the second housing 220 switches from the folded state to the unfolded state.

According to an embodiment, the first area 231 may be disposed on the first housing 210 and may be supported by the first housing 210. The second area 232 may be disposed on the second housing 220 and may be supported by the second housing 220. The folding area 233 may be connected to the first area 231 and the second area 232. The folding area 233 may be at least partially folded or unfolded. For example, when the state of the electronic device 101 varies, the folding area 233 of the flexible display 230 may be configured to be folded or unfolded.

According to an embodiment, the flexible display 230 may vary into the folded state or the unfolded state. For example, the flexible display 230 may vary between a state (e.g., the folded state) in which the first area 231 and the second area 232 face each other and a state (e.g., the unfolded state) in which the first area 231 and the second area 232 face substantially the same direction. For example, the flexible display 230 may be at least partially folded or unfolded as the first housing 210 and the second housing 220 rotate around the folding axis A.

According to an embodiment, as the first housing 210 and the second housing 220 rotate around the folding axis A, the electronic device 101 may include the folded state and the unfolded state. The folded state may be a state in which the first housing 210 and the second housing 220 face each other, and a state in which the angle formed between the front surface of the first housing 210 and the front surface of the second housing 220 is smaller than a predetermined angle (e.g., 10 degrees). The unfolded state may be a state in which the electronic device 101 is fully or partially unfolded, and may be a state in which the angle formed between the front surface of the first housing 210 and the front surface of the second housing 220 is equal to or larger than the predetermined angle. In the fully unfolded state (e.g., FIG. 2), the angle formed between the front surface of the first housing 210 and the front surface of the second housing 220 may be substantially 180 degrees, but the disclosure is not limited thereto.

FIG. 2 illustrates an unfolded state of an electronic device 101 in which a front surface of a first housing 210 and a front surface of a second housing 220 form an angle of about 180 degrees. FIG. 3 illustrates a folded state of an electronic device 101 in which a front surface of a first housing 210 and a front surface of a second housing 220 face each other. In the folded state, the first area 231 and the second area 232 of the flexible display 230 may be positioned to face each other, and the folding area 233 may be bent.

According to an embodiment, the folding of the electronic device 101 may be implemented in two ways: 'in-folding' in which the first area 231 and the second area 232 are folded to face each other, and 'out-folding' in which the first area 231 and the second area 232 are folded to face opposite directions. For example, in the state folded in the in-folding manner, the first area 231 and the second area 232 may be substantially concealed and, in the fully unfolded state, the first area 231 and the second area 232 may be disposed to face substantially the same direction. For example, in the state folded in the out-folding manner, the first area 231 and the second area 232 may be disposed to face opposite directions to be visible to the outside and, in the fully unfolded state, the first area 231 and the second area 232 may be disposed to face substantially the same direction.

According to an embodiment, the flexible display 230 may include a display panel (not illustrated) and a window member (not illustrated), and at least a portion thereof may be formed to be flexible. Although not illustrated, it may be easily understood by those skilled in the art that the flexible display 230 or display panel includes various layers such as a light-emitting layer, an encapsulating substrate(s) that encapsulates the light-emitting layer, an electrode or line layer, and/or an adhesive layer(s) that bonds different adjacent layers. When the flexible display 230 (e.g., the folding area 233) is deformed into a flat plate shape and a curved shape, relative displacement may occur between layers of the flexible display 230. The relative displacement according to the deformation of the first area 231 may increase as the point is farther from the folding axis A and/or as the thickness of the flexible display 230 increases.

According to an embodiment, the window member (e.g., the thin film plate) may serve as a protective film for protecting the display panel. As a protective film, the thin film plate may be formed of a material that protects the display panel from external impact and is resistant to scratches, and causes less creases in the folding area 233 even in repeated folding and unfolding operations of the housings 210 and 220. For example, the thin film plate may include a clear polyimide (CPI) film or ultra-thin glass (UTG).

According to an embodiment, the electronic device 101 may include a sub display 239. The sub display 239 may be defined and/or referred to as a rear display. The sub display 239 may be disposed to face a direction different from that of the flexible display 230 (e.g., the first area 231). For example, the flexible display 230 may be visible through the front surface (e.g., the first front surface 210a and/or the second front surface 220a) of the electronic device 101, and the sub display 239 may be visible through the rear surface (e.g., the first rear surface 210b or the first rear cover 240) of the electronic device 101. In the example embodiments of FIGS. 2 and 3, the position or size of the sub display 239 is an example, and the position or size thereof may vary according to embodiments.

According to an embodiment, the electronic device 101 may further include a protective member(s) 224-1, 224-2 (see, e.g., FIG. 4) disposed on at least a portion of the edge of the flexible display 230 on the front surface (e.g., the first surface 210a or the third surface 220a). The protective member(s) 224-1, 224-2 may be configured to prevent and/or reduce at least a portion of the edge of the flexible display 230 from contacting a mechanical structure (e.g., the first housing 210 or the second housing 220). The protective member(s) 224-1, 224-2 may include a first protective member 224-1 covering at least a portion of the edge of the first area 231 and a second protective member 224-2 covering at least a portion of the edge of the second area 232.

According to an embodiment, the speaker hole 245 may be formed in the first protective member 224-1 interposed between the edge of the first area 231 of the flexible display 230 and the inner wall of the first housing 210.

FIG. 4 is an exploded perspective view illustrating an electronic device according to various embodiments.

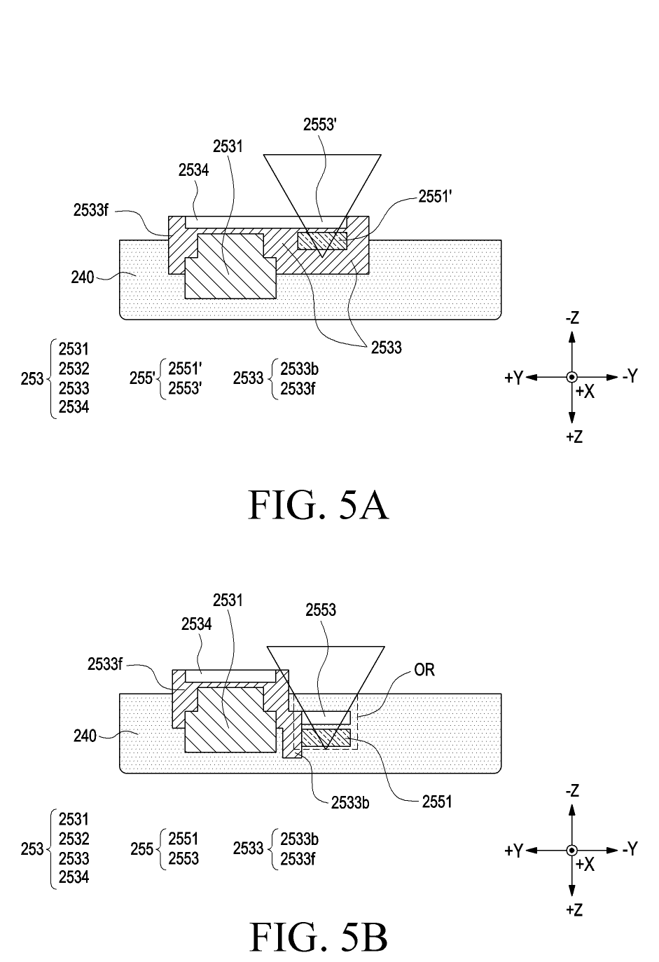

The example embodiment of FIG. 4 may be combined with the example embodiments of FIGS. 1-3, and/or with the example embodiments of FIGS. 5-17.

The configurations of the example embodiments of FIG. 4 may be identical in whole or part to the configurations of the example embodiments of FIGS. 1-3, and/or the configurations of the example embodiments of FIGS. 5-17.

Referring to FIG. 4, according to an embodiment, the flexible display 230 may be visible through a significant portion of the front surface of the electronic device 101. According to an embodiment, the shape of the flexible display 230 may be formed to be substantially the same as the shape of the periphery of the front surface of the electronic device 101.

According to an embodiment, the foldable housing 201 of the electronic device 101 (e.g., the foldable housing 201 of FIGS. 2 and 3 ) may include a first housing 210 and a second housing 220. According to an embodiment, the first housing 210 may include a first surface 210a and a second surface 210b opposite to the first surface 210a. The second housing 220 may include a third surface 220a and a fourth surface 220b opposite to the third surface 220a. The electronic device 101 or the foldable housing 201 may additionally or alternatively include a bracket assembly 217, 227. The bracket assembly 217, 227 may include a first bracket assembly 217 disposed in the first housing 210 and a second bracket assembly 227 disposed in the second housing 220. At least a portion of the bracket assembly 217, 227, e.g., at least a portion of the first bracket assembly 217 and at least a portion of the second bracket assembly 227, may be connected to the hinge structure 270.

According to an embodiment, various electric components may be disposed on the printed circuit board 216, 226. For example, a processor (e.g., the processor 120 of FIG. 1), memory (e.g., the memory 130 of FIG. 1), and/or an interface (e.g., the interface 177 of FIG. 1) may be mounted on the printed circuit board 216, 226. The processor may include one or more of, e.g., a central processing unit, an application processor, a graphic processing device, an image signal processing, a sensor hub processor, or a communication processor. The memory may include, e.g., a volatile or non-volatile memory. The interface may include, e.g., a high definition multimedia interface (HDMI), a universal serial bus (USB) interface, a secure digital (SD) card interface, and/or an audio interface. The interface may electrically or physically connect, e.g., the electronic device 101 with an external electronic device and may include a USB connector, an SD card/multimedia card (MMC) connector, or an audio connector.

According to an embodiment, the printed circuit boards 216, 226 may include a first printed circuit board 216 disposed on the side of the first bracket assembly 217 and a second printed circuit board 226 disposed on the side of the second bracket assembly 227. The first printed circuit board 216 and the second printed circuit board 226 may be disposed inside the space formed by the foldable housing 201 and the bracket assembly 217, 227. Components for implementing various functions of the electronic device 101 may be disposed on the first printed circuit board 216 and the second printed circuit board 226. For example, a processor may be disposed on the first printed circuit board 216, and an audio interface may be disposed on the second printed circuit board 226.

According to an embodiment of the disclosure, the battery 215, 225 may be configured to supply power to the electronic device 101 and may be disposed adjacent to the printed circuit board 216, 226. At least a portion of the batteries 215, 225 may be disposed on substantially the same plane as the printed circuit board 216 or 226. According to an embodiment, a first battery 215 may be disposed adjacent to the first printed circuit board 216, and a second battery 225 may be disposed adjacent to the second printed circuit board 226. The batteries 215, 225 may be a device for supplying power to at least one component of the electronic device 101. The battery 189 may include, e.g., a primary cell which is not rechargeable, a secondary cell which is rechargeable, or a fuel cell. The batteries 215, 225 may be integrally or detachably disposed inside the foldable housing 210, 220, 260.

According to an embodiment, the hinge structure 270 may be a component to provide a folding axis (e.g., the folding axis A of FIG. 2) and rotatably connect or couple the foldable housing 201 and/or the bracket assembly 217, 227. The hinge structure 270 may include a first hinge structure 271 disposed on the side of the first printed circuit board 216 and a second hinge structure 272 disposed on the side of the second printed circuit board 226. The hinge structure 270 may be disposed between the first printed circuit board 216 and the second printed circuit board 226. According to an embodiment, the hinge structure 270 may be formed substantially integrally with at least a portion of the first bracket assembly 217 and at least a portion of the second bracket assembly 227.

According to an embodiment, the 'housing structure' may include a foldable housing 201 and at least one component disposed inside the foldable housing 201 and assembled and/or coupled with the foldable housing 201. The housing structure may include a first housing structure and a second housing structure. For example, a component assembled including the first housing 210 and the first bracket assembly 217 disposed inside the first housing 210 may be referred to as a ‘first housing structure.’ As another example, a component assembled including the second housing 220 and the second bracket assembly 227 disposed inside the second housing 220 may be referred to as a ‘second housing structure.’ However, it should be noted that the 'first housing structure and the second housing structure' are not limited to the addition of the above-described components, but may add or omit various other components.

According to an embodiment, the electronic device 101 may include a flexible connecting member 280. The flexible connecting member 280 may be, e.g., a flexible printed circuit board (FPCB). The flexible connecting member 280 may connect various electrical elements disposed on the first printed circuit board 216 and the second printed circuit board 226. To this end, the flexible connecting member 280 may be disposed to cross the 'first housing structure' and the 'second housing structure'. According to an embodiment, the flexible connecting member 280 may be disposed to cross at least a portion of the hinge structure 270. According to an embodiment, the flexible connecting member 280 may be configured to connect the flexible printed circuit board 216 and the second printed circuit board 226 across the hinge structure 270 along a direction parallel to, e.g., the X axis of FIG. 4. As another example, the flexible connecting member 280 may extend or be disposed through the openings 273, 274 formed in the hinge structure 270. In this case, a portion 281 of the flexible connecting member 280 may be disposed over one side (e.g., upper portion) of the first hinge structure 271, and another portion 282 of the flexible connecting member 280 may be disposed over one side (e.g., upper portion) of the second hinge structure 272. At least a portion 283 of the flexible connecting member 280 may be disposed on the other side (e.g., lower portion) of the first hinge structure 271 and the second hinge structure 272. A space (hereinafter, referred to as a ‘wiring space’) surrounded by at least a portion of the first hinge structure 271, at least a portion of the second hinge structure 272, and at least a portion of the hinge cover 260 may be formed in a position adjacent to the first hinge structure 271 and the second hinge structure 272. According to an embodiment, at least a portion 283 of the flexible connecting member 280 may be disposed in the wiring space.

According to an embodiment, the hinge cover 260 may be a component that covers at least a portion of the hinge structure 270 or the wiring space. In an embodiment, the hinge cover 260, together with the hinge structure 270, may form the wiring space and protect components (e.g., at least a portion 283 of the flexible connecting member 280) disposed in the wiring space from external impact. According to an embodiment, the hinge cover 260 may be disposed between the first housing 210 and the second housing 220. In the electronic device 101 which is of an in-folding type, the hinge cover 260 may be at least partially concealed by the first housing 210 and the second housing 220. For example, in the folded state (e.g., FIG. 3), the hinge cover 260 may be visually exposed to the external space between the rear surface (e.g., the first back cover 240) of the first housing 210 and the back cover (e.g., the second back cover 250) of the second housing 220 and, in the unfolded state (e.g., FIG. 2), the hinge cover 360 may be substantially received inside the first housing 210 or the second housing 220 to be visually concealed.

According to an embodiment, the electronic device 101 may include an antenna module 219, 229 (e.g., the antenna module 197 of FIG. 1). The antenna modules 219, 229 may be disposed between the rear cover 240, 250 and the battery 215, 225. According to an embodiment, the antenna module 219, 229 may include a first antenna module 219 disposed on the side of the first housing 210 and a second antenna module 229 disposed on the side of the second housing 220. The antenna module 219, 229 may include, e.g., a near field communication (NFC) antenna, a wireless charging antenna, and/or a magnetic secure transmission (MST) antenna, performing short-range communication with an external device or wirelessly transmitting/receiving power required for charging. In an embodiment, an antenna structure may be formed by a portion or combination of the side bezel structure of the foldable housing 201 and/or bracket assembly.

According to an embodiment, the rear cover 240, 250 may include a first rear cover 240 and a second rear cover 250.

Referring to FIG. 4, an example is described in which the first rear cover 240 is included in the first housing 210, and the second rear cover 250 is included in the second housing 220, but the disclosure is not limited thereto. For example, the first rear cover 240 may be coupled to the first housing 210, and the second rear cover 250 may be coupled to the second housing 220. The rear covers 240 and 250 may be coupled with the housings 210 and 220 to protect the above-described components (e.g., printed circuit boards 216 and 226, batteries 215 and 225, flexible connecting members 280, or antenna modules 219 and 229) disposed in the foldable housing 201. The rear covers 240 and 250 may be formed substantially integrally with the housings 210 and 220.

According to an embodiment, the first protective member 224-1 and the second protective member 224-2 may protect at least a portion of the edge of the flexible display 230. The first protective member 224-1 may be at least partially disposed between the edge of the first area 231 of the flexible display 230 and the inner wall of the first housing 210, and may cover the edge of the first area 231. The second protective member 224-2 may be at least partially disposed between the edge of the second area 232 of the flexible display 230 and the inner wall of the second housing 220, and may cover the edge of the second area 232.

According to an embodiment, the flexible display 230 may include a first area 231, a second area 232, and a folding area 233. The first area 231 may be supported by the front surface 210a of the first housing 210 (e.g., the front surface of the first bracket assembly 217). The second area 232 may be supported by the front surface 220a of the second housing 220 (e.g., the front surface of the second bracket assembly 227). The folding area 233 may be disposed between the first area 231 and the second area 232, and may be connected to the first area 231 and the second area 232. The folding area 233 may be disposed over the hinge structure 270.

FIGS. 5A and 5B are cross-sectional views illustrating a portion of an electronic device according to various embodiments.

The example embodiment of FIG. 5 may be combined with the example embodiments of FIGS. 1-4 and/or 6-17.

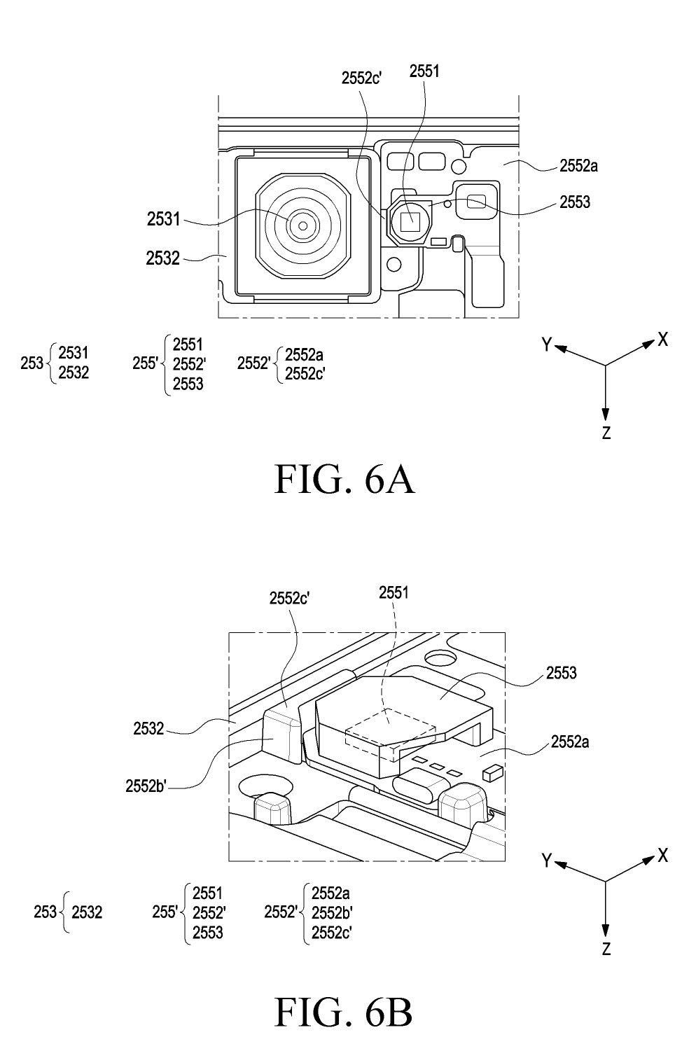

Some or all of the components described with reference to FIG. 5 may be the same as those described with reference to FIGS. 1-4. Some or all of the components described with reference to FIG. 5 may be the same as all or some of the components described with reference to FIGS. 6-17.

According to an embodiment, the camera module 253 may further include a camera 2531, a camera cover 2533, and a camera module transparent member 2534. According to an embodiment, the camera module 253 may be disposed under the display (e.g., the sub display 239 of FIG. 3). According to an embodiment, the camera module 253 may be disposed on the second direction (e.g., +Z direction) side of the display (e.g., the sub display 239 of FIG. 3). According to an embodiment, the camera module 253 may be disposed in the second direction (e.g., the +Z-axis direction) of the display (e.g., the sub display 239 of FIG. 3).

In the example, the camera 2531, the camera cover 2533, and the camera module transparent member 2534 are illustrated as components of the camera module 253, but other additional components (e.g., the camera bracket 2532 to be described below in FIG. 6) are not excluded.

According to an embodiment, the camera 2531 may be disposed to face the outside of the electronic device. The camera 2531 may be disposed to face the first direction (e.g., the -Z-axis direction) toward the outside of the electronic device. Accordingly, the image of the subject outside the electronic device may be obtained.

A camera bracket (e.g., the camera bracket 2532 to be described below in FIG. 6) may be provided to support the camera 2531. According to an embodiment, the camera bracket (e.g., the camera bracket 2532 to be described below in FIG. 6) may be configured to surround at least a portion of the camera 2531 in a direction perpendicular to the second direction (e.g., the +Z-axis direction). Accordingly, the camera bracket (e.g., the camera bracket 2532 to be described below in FIG. 6) may support the camera 2531 and protect the camera 2531 from external impact.

According to an embodiment, the camera cover 2533 may be referred to as a "deco member". According to an embodiment, the camera cover 2533 may be disposed in the first direction (e.g., the -Z-axis direction) of the camera 2531. According to an embodiment, the camera cover 2533 may be configured to at least partially surround the camera 2531 in a direction perpendicular to the second direction (e.g., the +Z-axis direction). Accordingly, the camera cover 2533 may not only form the exterior of the electronic device, but also primarily protect the camera 2531 from external impact. According to an embodiment, the camera module transparent member 2534 may be disposed in the first direction (e.g., the -Z-axis direction) of the camera 2531 and may be configured to be surrounded by the camera cover 2533 in a direction perpendicular to the second direction (e.g., the +Z-axis direction). Accordingly, the camera module transparent member 2534 may be protected from an external environment, and the optical performance of the camera 2531 may be prevented/reduced from deteriorating by preventing and/or reducing penetration of external foreign objects.

Further, the camera module transparent member 2534 may guide light incident on the camera module 253 and may be thereby configured to gather light to focus it and minimize/reduce distortion to form a clear image. The arrangement of the camera module transparent member 2534 may be designed to minimize/reduce diffuse reflection and optical distortion that may occur when the camera 2531 performs capturing. Accordingly, the capturing quality of the camera 2531 may be enhanced.

According to an embodiment, the first rear cover 240 may be integrated with a camera bracket (e.g., the camera bracket 2532 of FIG. 6) to form a rear surface of the electronic device. According to an embodiment, the first rear cover 240 may have an empty space formed at a position corresponding to the rear cover opening OR. As an empty space is formed at a position corresponding to the rear cover opening OR, the light emitted from the light-emitting diode 2551 may be transferred to the outside through the rear cover opening OR.

Further, the camera 2531, the camera cover 2533, and the camera module transparent member 2534 of the camera module 253 may protrude in the first direction (e.g., the Z-axis direction) further than the first rear cover 240 of the rear surface of the electronic device. This may be a natural shape to reduce the height (height or thickness in the Z-axis direction) of the electronic device to meet the trend of slimming and lightening of the electronic device while maintaining the optical performance of the camera module 253 for high-quality image capturing.

According to an embodiment, at least a portion of the camera cover 2533 protruding in the first direction (e.g., the Z-axis direction) further than the first rear cover 240 of the rear surface of the electronic device may be defined as a first protrusion 2533f.

According to an embodiment, the first protrusion 2533f is formed to form the exterior of the electronic device when viewed from the outside of the electronic device, and may be configured to surround at least a portion of the camera 2531 and/or the camera module transparent member 2534. According to an embodiment, the first protrusion 2533f may be configured to protrude in the first direction (e.g., the -Z-axis direction) further than the first rear cover 240.

According to an embodiment, the camera cover 2533 may include a second protrusion 2533b, and the second protrusion 2533b may be a portion of the rear cover 240 and/or the camera bracket (e.g., the camera bracket 2532 of FIG. 6).

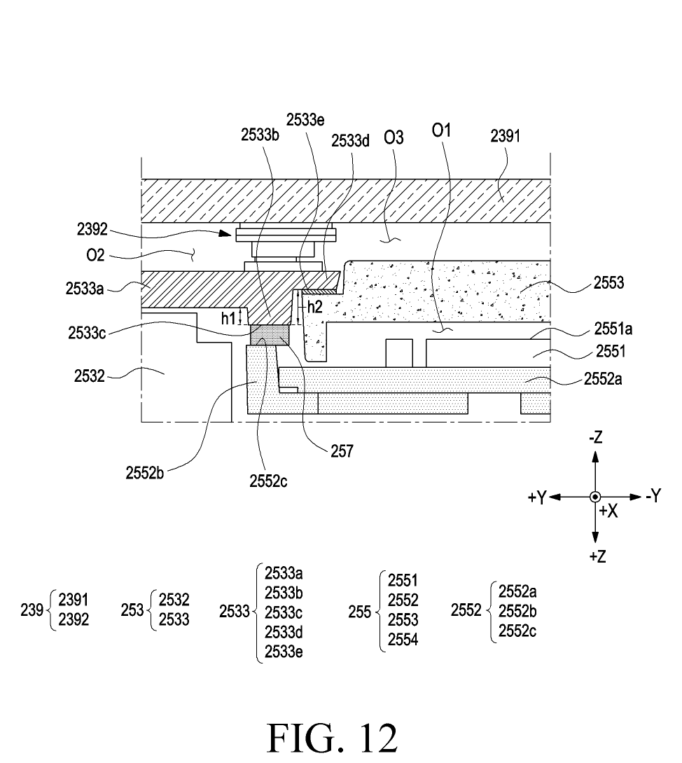

In the example, the first protrusion 2533f is illustrated as a component of the camera cover 2533, but other additional components are not excluded. For example, the camera cover 2533 may further include the camera cover body 2533a, the camera cover protruding surface 2533c, the horizontal portion 2533d, and the connecting member 2533e of FIG. 12 to be described below.

In the disclosure, an example in which a camera bracket (e.g., the camera bracket 2532 of FIG. 6 to be described in greater detail below) and the first rear cover 240 are integrated to form the rear surface is described, but the disclosure is not limited thereto. For example, the camera bracket (e.g., the camera bracket 2532 of FIG. 6 to be described in greater detail below) supports the camera 2531 as a separate component, and the camera 2531, the camera cover 2533, and the camera module transparent member 2534 of the camera module 253 may protrude in the first direction (e.g., the Z-axis direction) further than the first rear cover 240.

Due to this structure, when the electronic device is viewed in the third direction (e.g., the Y-axis direction) perpendicular to the first direction (e.g., the -Z-axis direction), a portion of the camera module 253 may protrude in the first direction (e.g., the -Z-axis direction) further than the rear surface (e.g., the first rear cover 240) of the electronic device.

According to an embodiment, the light-emitting module 255 (e.g., a flash module) may include a light-emitting diode 2551, 2551' and a transparent member 2553, 2553'. According to an embodiment, the light-emitting module 255 may be disposed under the display (e.g., the sub display 239 of FIG. 3). According to an embodiment, the light-emitting module 255 may be disposed on the second direction (e.g., the +Z direction) side of the display (e.g., the sub display 239 of FIG. 3). According to an embodiment, the light-emitting module 255 may be disposed in the second direction (e.g., the +Z-axis direction) of the display (e.g., the sub display 239 of FIG. 3). According to an embodiment, the light-emitting module 255 may be disposed adjacent to the camera module 253. The light-emitting module 255 may be disposed in the third direction (e.g., the -Y-axis direction) perpendicular to the second direction (e.g., the +Z-axis direction) of the camera module 253.

In this example, a light-emitting module bracket (e.g., the light-emitting module bracket 2552 of FIG. 6) configured to support the light-emitting module 255, 255' is not illustrated, but the disclosure is not limited thereto. For example, as illustrated, the light-emitting module 255, 255' may be provided such that the bracket (e.g., the light-emitting module bracket 2552 of FIG. 6) for supporting the light-emitting module 255, 255' is integrated with the camera bracket (e.g., the camera bracket 2532 of FIG. 6 to be described below) for supporting the camera module 253. Alternatively, the light-emitting module 255, 255' may include a separate bracket (e.g., the light-emitting module bracket (2552 of FIG. 6) as in the example embodiments to be described in greater detail below.

According to an embodiment, the light-emitting diode 2551, 2551' may include an electrical device that is disposed in the first direction (e.g., the -Z-axis direction) of the light-emitting module bracket (e.g., the light-emitting module bracket 2552 of FIG. 6) or the rear cover 240, to emit light when an external subject is captured using the camera module 253 or a flashlight function is used.

According to an embodiment, the transparent member 2553, 2553' may be disposed in the first direction (e.g., the -Z-axis direction) of the light-emitting diode 2551, 2551' and configured to protect the light-emitting diode 2551, 2551' from external impact, control directivity of light emitted from the light-emitting diode 2551, 2551', and accurately transfer the light required for capturing to the subject.

Referring to FIG. 5A, the light-emitting module 255, 255' may be formed to protrude in the first direction (e.g., the -Z-axis direction) further than the rear cover 240 of the rear surface of the electronic device. According to an embodiment, the light-emitting module 255, 255' may be disposed in the first direction (e.g., the -Z-axis direction) of the camera bracket (e.g., the camera bracket 2532 of FIG. 6 to be described in greater detail below) and/or the first rear cover 240, and may be configured to be surrounded by the camera cover 2533 in a direction perpendicular to the first direction (e.g., the -Z-axis direction).

According to the example embodiment of FIG. 5A, since the light emitted from the light-emitting diode 2551' propagates in the first direction (e.g., the -Z-axis direction), the possibility of the light emitted from the light-emitting diode 2551' being transferred to the camera 2531 may be decreased, thereby reducing the possibility of noise (e.g., light leakage) occurring in the captured result of the camera 2531.

However, in order to slim and lighten the electronic device, the light-emitting module 255 may be configured to be surrounded in a direction perpendicular to the first direction (e.g., the -Z-axis direction) by the rear cover 240 of the rear surface of the electronic device, as illustrated in FIG. 5B.

Referring to FIG. 5B, the light emitted from the light-emitting diode 2551 may be reflected from the inside of the rear cover 240 and transferred to the camera 2531, and in this case, noise (e.g., light leakage) may occur in the captured result (e.g., image and/or video) of the camera 2531.

Accordingly, a partition wall is disposed between the camera module 253 and the light-emitting module 255 to effectively prevent/block noise (e.g., light leakage) that may occur in the captured result, while slimming and lightening the electronic device.

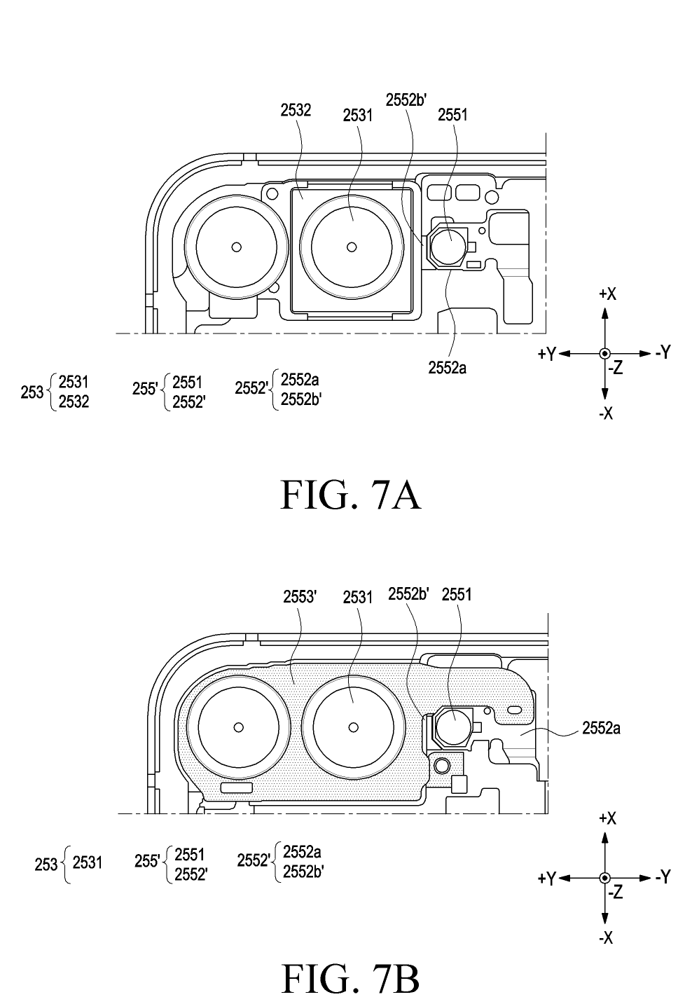

FIGS. 6A and 6B include a plan view and a perspective view illustrating a portion of an electronic device according to various embodiments. FIGS. 7A and 7B are diagrams illustrating plan views of a portion of an electronic device according to various embodiments.

The example embodiment of FIGS. 6A, 6B, 7A and 7B (which may be referred to as FIGS. 6 and 7) may be combined with the example embodiments of FIGS. 1-5 and/or FIGS. 8-17.

Some or all of the elements described with reference to FIGS. 6 and 7 may be the same as those described with reference to FIGS. 1-5. Some or all of the components described with reference to FIGS. 6 and 7 may be the same as all or some of the components described with reference to FIGS. 8-17.

According to an embodiment, the light-emitting module 255' may include a light-emitting diode 2551, a light-emitting module bracket 2552', and a transparent member 2553.

According to an embodiment, as described above, the light-emitting diode 2551 may be an electrical device that emits light when capturing an external subject using the camera module 253 or using a flashlight function. In general, the light-emitting diode 2551 is used as a light-emitting body.

According to an embodiment, the light-emitting diode 2551 may be disposed adjacent to the camera module 253 in the third direction (e.g., the Y-axis direction) to provide light required for the camera module 253 to perform capturing.

According to an embodiment, the light-emitting module bracket 2552' may be configured to protect and support the printed circuit board disposed on the light-emitting diode 2551 and the light-emitting module 255'. Further, the light-emitting module bracket 2552' may be disposed in the second direction (e.g., the +Z-axis direction) of the light-emitting diode 2551.

According to an embodiment, the light-emitting module bracket 2552' may be configured to disperse the heat generated from the light-emitting diode 2551. The heat generated from the light-emitting diode 2551 may be transferred to the periphery together with the printed circuit board, and the light-emitting module bracket 2552' may receive the heat from the light-emitting diode 2551 and effectively disperse the received heat. Further, the light-emitting module bracket 2552' may be configured to fix the positions of the light-emitting diode 2551 and the printed circuit board, which may enhance the performance and durability of the light-emitting module 255'.

According to an embodiment, the light-emitting module bracket 2552' may include a light-emitting module bracket body 2552a, a light-emitting module bracket protrusion 2552b', and a light-emitting module bracket protruding surface 2552c'.

According to an embodiment, the light-emitting module bracket body 2552a may be disposed in the second direction (e.g., the +Z-axis direction) of the light-emitting diode 2551 and the transparent member 2553 and configured to support the light-emitting diode 2551 and the transparent member 2553. Further, the light-emitting module bracket body 2552a may have a flat plate shape substantially parallel to the rear surface of the electronic device.

According to an embodiment, the light-emitting module bracket protrusion 2552b' may be a portion protruding from the light-emitting module bracket body 2552a in the first direction (e.g., the -Z-axis direction) to prevent/block noise (e.g., light leakage) from occurring as the light emitted from the light-emitting diode 2551 is transferred to the camera 2531.

According to an embodiment, the light-emitting module bracket protrusion 2552b' may be configured to block a portion of the path through which light emitted from the light-emitting diode 2551 is transferred, thereby preventing/blocking the light emitted from the light-emitting diode 2551 from being transferred to the camera 2531.

According to an embodiment, the light-emitting module bracket protruding surface 2552c' may refer, for example, to one surface disposed in the first direction (e.g., the -Z-axis direction) of the light-emitting module bracket protrusion 2552b'. The light-emitting module bracket protruding surface 2552c' may be configured to protrude above the light-emitting module bracket 2552' to face the camera bracket 2532 or the camera cover 2533.

According to an embodiment, the transparent member 2553 may be a component to adjust the refraction of light so that light emitted from the light-emitting diode 2551 may reach a desired direction. For optical reasons, the distance to the light-emitting diode 2551 and an arrangement relationship with the light-emitting diode 2551 may be important. The transparent member 2553 also ensures efficient light emission of the light-emitting diode 2551, thereby optimizing the performance of the camera module 253.

According to an embodiment, the light-emitting module 255 may further include a printed circuit board. The printed circuit board disposed on the light-emitting module 255 is a circuit board on which a component for operating the light-emitting diode 2551 is mounted, and may supply power to the light-emitting diode 2551 and at the same time transfer heat generated from the light-emitting diode 2551 to the surroundings. The printed circuit board may provide a necessary electrical path for the light-emitting diode 2551 and other components to operate stably, and efficiently disperse heat to allow the light-emitting diode to operate stably. Accordingly, the performance of the light-emitting diode 2551 is optimized and a problem caused by overheating is prevented/reduced.

According to an embodiment, the camera module 253 may further include a camera 2531, a camera bracket 2532, and a camera cover 2533. According to an embodiment, the camera module 253 may be disposed adjacent to the light-emitting module 255' in the third direction (e.g., +Y-axis direction).

According to an embodiment, the camera 2531 is an electrical device that captures an image of a subject using an optical sensor, and may include one or more lenses, an optical sensor, an auto focus (AF) actuator, or the like. The plurality of components may operate in cooperation with each other to capture a high-quality image.

The camera 2531 may react sensitively to an external impact. For example, interaction between components inside the camera 2531 may not be smoothly performed due to an external impact. For this reason, the durability of the camera 2531 may be an important design factor when manufacturing the camera module 253.

However, recently, the camera 2531 is disposed in the electronic device, but it is designed to protrude outside the electronic device (e.g., a shape protruding outside the electronic device and toward the first direction (e.g., the -Z-axis direction)). This is done so considering functions such as design and image quality, but as a result, the camera 2531 may be disposed on the electronic device in a state in which it is more vulnerable to external impact. Therefore, when the camera 2531 is designed to protrude, an additional design is needed to strengthen the durability of protecting the camera 2531 from external impact.

According to an embodiment, the camera bracket 2532 may protect the camera 2531 from an external impact. When an impact is applied from the outside of the electronic device, the camera bracket 2532 may absorb the impact and disperse the impact. Accordingly, damage to the camera 2531 may be prevented/reduced and durability of the electronic device may be enhanced.

The camera bracket 2532 may be formed of a solid material to increase durability, and may be designed considering internal heat dissipation as well as external impact. The material of the camera bracket 2532 may be generally metal (e.g., aluminum alloy) or high strength plastic, and it may be important to effectively disperse the impact and maintain light weight.

According to an embodiment, the camera cover 2533 may be a component for protecting the camera 2531. Specifically, as the camera 2531 is implemented in a protruding shape to the outside, the camera cover 2533 may be disposed adjacent to the camera 2531 as a component to protect it. The camera cover 2533 may be configured to protect the camera 2531 from external impact and to disperse external impact.

In order to achieve weight reduction and slimming of the electronic device, the camera cover 2533 may be manufactured from a material that is lightweight yet exhibits excellent rigidity. In general, aluminum alloys or reinforced plastics having lightweight and strong properties may be used, which not only protects the camera 2531 from external impact but also contributes to enhancing the exterior design of the electronic device.

Accordingly, the camera cover 2533 may be designed considering not only a functional role but also an aesthetic factor. Surface finishing (e.g., matte coating, high-gloss finish, pattern design, etc.) may be designed to harmonize with the overall design of the electronic device, and may also increase the user's visual satisfaction.

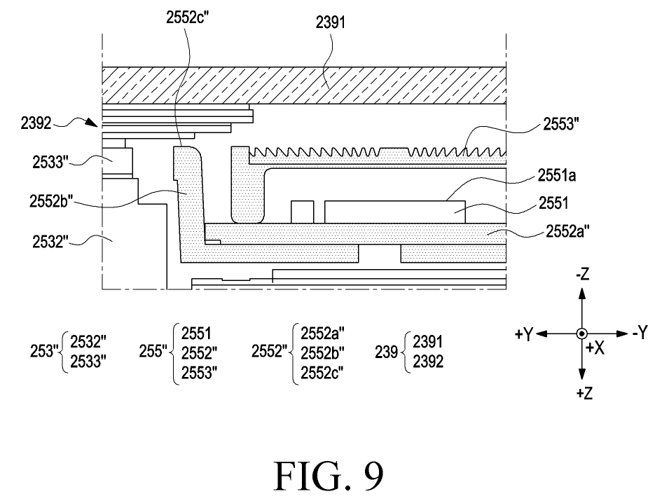

FIG. 8 is a cross-sectional view illustrating a camera module, a light-emitting module, and a display panel of an electronic device according to various embodiments. FIG. 9 is a cross-sectional view illustrating a camera module, a light-emitting module, and a display panel of an electronic device according to various embodiments.

The example embodiment of FIGS. 8 and 9 may be combined with the example embodiments of FIGS. 1-7 and/or 10-17.

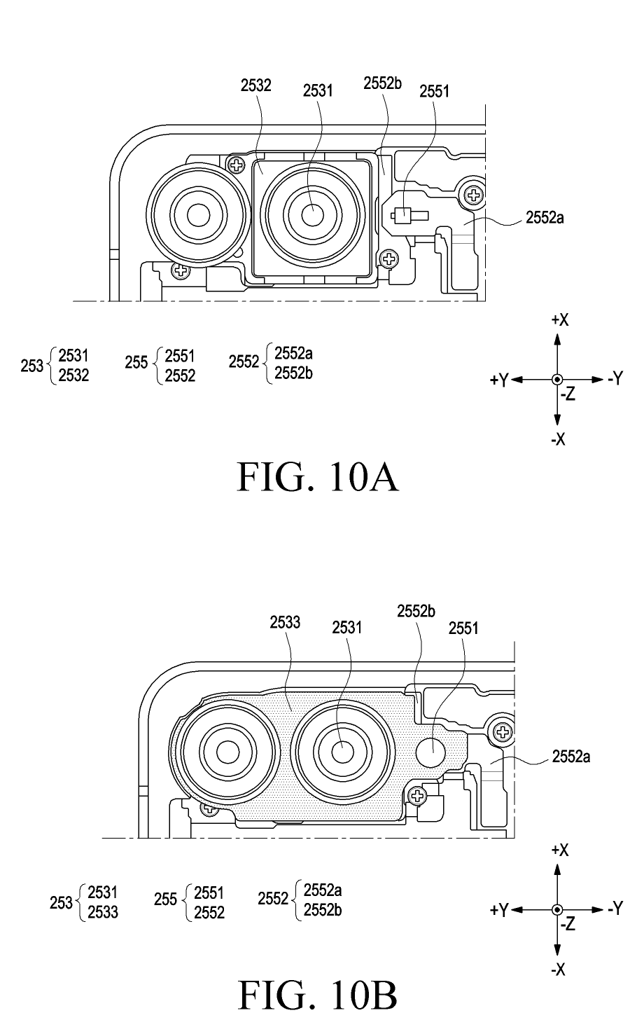

Some or all of the components described with reference to FIGS. 8 and 9 may be the same as those described with reference to FIGS. 1 to 7. Some or all of the components described with reference to FIGS. 8 and 9 may be the same as those described with reference to FIGS. 10 to 17.

According to an embodiment, the display 239 (e.g., the sub display 239 of FIG. 3) may be accommodated in the housing (e.g., the housing 201 of FIGS. 3 and 4) of the electronic device so that a screen is viewed in the first direction (e.g., the -Z direction) facing the outside of the electronic device.

According to an embodiment, the above-described first rear cover (e.g., the first rear cover 240 of FIG. 2) may include a window 2391, and the display 239 (e.g., the sub display 239 of FIG. 3) may include a display panel 2392.

According to an embodiment, the window 2391 may be configured to protect the display panel 2392. For example, the window 2391 may be configured to include glass or acrylic. Further, the window 2391 may be in the form of a film including polyester (PET), polycarbonate (PC), or polyurethane (PT).

According to an embodiment, the window 2391 is highly durable and may affect visual quality of an image visible to the outside through the display panel 2392. The window 2391 may be configured to prevent or reduce the internal components of the display panel 2392 from being deformed, damaged, or contaminated by an external impact.

The window 2391 may include a transparent material to transfer the light dispersed from the display 239 (e.g., the sub display 239 of FIG. 3) to the outside. According to an embodiment, the description of the first rear cover 240 made in connection with FIGS. 2 and 3 may be applied equally to the window 2391. For example, the window 2391 may be at least partially transparent and may be interpreted as a portion of display module 239.

According to an embodiment, the window 2391 may be utilized in a display including a touch screen. For example, the window 2391 may be a portion to which the user's touch is input. The window 2391 may be configured to form an exterior of the electronic device 101 so that the user may use a touch screen function.

According to an embodiment, the display panel 2392 may be disposed in the second direction (e.g., the +Z-axis direction) of the window 2391. Further, the display panel 2392 is a device that receives an electrical signal and displays a visual image or video on the screen, and may properly convert the input signal and transmit it in the form that may be recognized by the user. The display panel 2392 may optimize image quality on the screen by adjusting color, brightness, resolution, or the like, so that the user may be provided with clear and accurate visual information. It may be used to display various contents through its function capable of responding to various input signals.

Referring to the example embodiment of FIG. 8, in the case of a bar-type electronic device, since the window 2391 is disposed in the first direction (e.g., the -Z-axis direction) of the light-emitting module 255' and the space in the height direction (e.g., the first direction (e.g., the -Z-axis direction)) of the electronic device is sufficient, the length of the light-emitting module bracket protrusion 2552b' in the first direction (e.g., the -Z-axis direction) may be elongated in order to prevent/block the light emitted from the light-emitting diode 2551 from leaking out in an unnecessary direction.

Referring to the example embodiment of FIG. 9, when the electronic device is designed in the form of a foldable electronic device, the display panel 2392 may be disposed between the window 2391 and the light-emitting module bracket protrusion 2552b" while facing the light-emitting module bracket protruding surface 2552c'' due to a limitation in the mounting space in the height direction (e.g., the first direction (e.g., the -Z-axis direction)) of the electronic device.

In the structure according to the example embodiment of FIG. 9, when the length of the light-emitting module bracket protrusion 2552b'' in the first direction (e.g., the -Z-axis direction) is elongated, the likelihood that impact is applied to the display panel 2392 to be damaged increases. Therefore, it is necessary to design the shape and height of the light-emitting module bracket protrusion 2552b'' that prevents/blocks light emitted from the light-emitting diode 2551 from leaking in an unnecessary direction while minimizing/reducing the physical impact on the display panel 2392.

Referring to the example embodiments of FIGS. 8 and 9, when a mounting space limitation occurs in the height direction (e.g., the first direction (e.g., the -Z-axis direction)) of the foldable electronic device, the durability of the light-emitting diode 2551 and the display 239 (e.g., the sub display 239 of FIG. 3) should also be considered when designing the electronic device.

As in the example embodiment of FIG. 8, in the case of a bar-type electronic device, the window 2391 is disposed in the first direction (e.g., the -Z-axis direction) of the transparent member 2553, and the gap between the transparent member 2553 and the window 2391 may be designed to be about 0.2 mm or more.

However, when the electronic device is designed in the form of a foldable electronic device as in the example embodiment of FIG. 9, the gap between the transparent member 2553 and the window 2391 may be decreased to 0.2 mm or less due to the mounting space limitation in the height direction (e.g., the first direction (e.g., the -Z-axis direction)) of the electronic device, and thus durability may decrease as the gap between the light-emitting diode 2551 and the display 239 (e.g., the sub display 239 of FIG. 3) decreases.

For example, in a hole in display (HID) structure, since the display panel 2392 is disposed under the window 2391, the possibility of damage to the display panel 2392 and the transparent member 2553 may increase significantly in the event of a drop and/or external impact when the gap between the transparent member 2553 and the window 2391 is reduced.

The hole in display (HID) structure may refer, for example, to forming an opening (e.g., the second opening O2 of FIG. 12 and the third opening O3 of FIG. 12) in at least one portion of the display panel 2392. Through this HID structure, the display panel 2392 may be disposed adjacent to a component that transfers, or should transfer, light toward the external subject, such as the camera module 253 or the light-emitting module 255''.

Referring to the example embodiments of FIGS. 8 and 9, when a mounting space limitation occurs in the height direction (e.g., the first direction (e.g., the -Z-axis direction) of the foldable electronic device, heat generation of the light-emitting modules 255' and 255' should also be considered when designing the electronic device.

Referring to the example embodiment of FIG. 9, when the electronic device is designed in the form of a foldable electronic device, the heat dissipation structure of the electronic device is separately mounted in the first housing 210 and the second housing 220, and thus when the light-emitting module 255'' generates heat in the first housing 210, the heat generated in the light-emitting module 255'' may not be effectively transferred to the heat dissipation structure of the second housing 220. As a result, there is a possibility that the heat generation of the light-emitting diode 2551 may be intensively accumulated in the heat dissipation structure disposed in the first housing 210, and as a result, the temperature of the electronic device may be higher than that of the bar-type electronic device according to FIG. 8.

The volume of metal components around the light-emitting module 255'' may also be an important factor in heat generation control. For example, if the volume of the camera cover 2533'' disposed around the light-emitting module 255 is small, the heat generated by the light-emitting diode 2551 may not be effectively dispersed but may be accumulated. For example, the heat generated from the light-emitting module 255'' may be transferred to the camera cover 2533'' along the light-emitting module bracket 2552''. Therefore, in order to enhance thermal management performance of the light-emitting module 255'', the volume and thermal conduction characteristics of the camera cover 2533'' should be considered.

According to an embodiment, in order to enhance the heat dissipation performance of the light-emitting module 255'', a design change such as adjusting the driving current of the light-emitting diode 2551 or extending the area of the printed circuit board FPCB may be applied. For example, it is possible to reduce the amount of heat generation by appropriately adjusting the current of the light-emitting diode 2551, or to increase the heat dissipation effect by applying a material with enhanced heat dissipation characteristics.

According to an embodiment, in order to enhance heat dissipation performance while maintaining the durability of the light-emitting module 255, an arrangement method and structural reinforcement of the light-emitting diode 2551 may be additionally considered. For example, a method of changing the shape of the light-emitting module bracket 2552'' surrounding the light-emitting diode 2551 or enhancing thermal resistance characteristics of the transparent member 2553 may be applied. Through the design change, the light-emitting module 255'' of the electronic device may operate more stably.

In the disclosure, by changing the shapes of the camera cover (e.g., the camera cover 2533 of FIG. 12) and the light-emitting module bracket protrusion (e.g., the light-emitting module bracket protrusion 2552b of FIG. 12), noise (e.g., light leakage) generated in the camera 2531 may be prevented/reduced, durability of the display 239 (e.g., the sub display 239 of FIG. 3) may be secured, and heat generated from the light-emitting module (e.g., the light-emitting module 255 of FIG. 12) may be effectively dispersed.

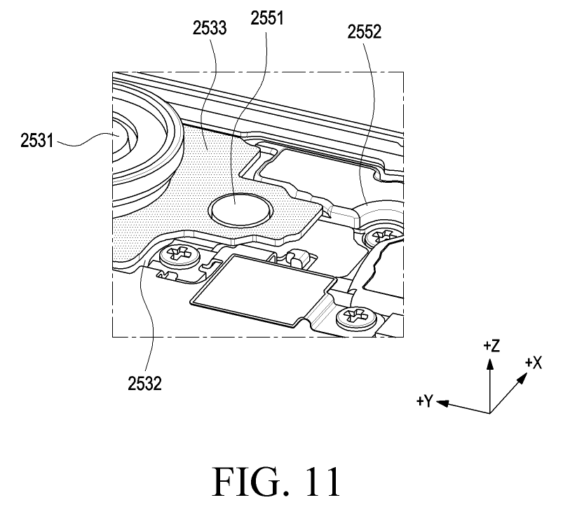

FIGA. 10A and 10B are plan views illustrating a portion of an electronic device according to various embodiments. FIG. 11 is a perspective view illustrating a portion of an electronic device according to various embodiments. FIG. 12 is a cross-sectional view illustrating a camera module, a light-emitting module, and a display panel of an electronic device according to various embodiments.

The example embodiment of FIGS. 10-12 may be combined with the example embodiments of FIGS. 1-9 and/or 13-17.

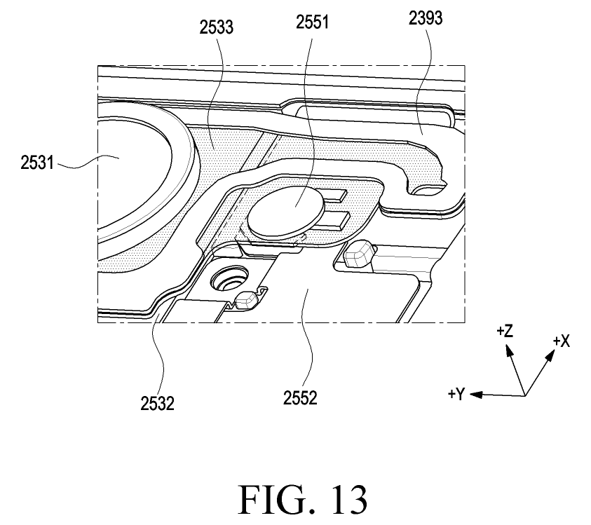

Some or all of the components described with reference to FIGS. 10-12 may be the same as the components described with reference to FIGS. 1-9. Some or all of the components described with reference to FIGS. 10-12 may be the same as all or some of the components described with reference to FIGS. 13-17.

According to an embodiment, an elastic member 257 may be further formed between the camera cover 2533 and the light-emitting module bracket 2552. According to an embodiment, the elastic member 257 may be connected to the light-emitting module bracket protrusion 2552b and/or the second protrusion 2533b.

According to an embodiment, the elastic member 257 may be configured to not only generate an elastic force in the first direction (e.g., the -Z-axis direction) or the second direction (e.g., the +Z-axis direction), but also transfer the heat generated from the light-emitting module 255 to the camera cover 2533, thereby effectively dispersing the heat generated from the light-emitting module 255.

For example, the heat generated by the light-emitting diode 2551 may be transferred to the light-emitting module bracket 2552 through a printed circuit board disposed in the light-emitting diode 2551, and the heat transferred to the light-emitting module bracket 2552 may be transferred to the elastic member 257. Further, the heat transferred to the elastic member 257 may be transferred to the camera bracket 2532, the window 2391, and/or the display panel 2392 through the camera cover 2533 and spread outside the electronic device.

When an impact is transferred from the outside, the impact transferred through the window 2391 may be transferred to the display panel 2392, and the impact transferred to the display panel 2392 may be transferred to the elastic member 257 through the camera cover 2533. In this case, the elastic member 257 may generate an elastic force in the first direction (e.g., the -Z-axis direction) or the second direction (e.g., the +Z-axis direction) to absorb external impact.

According to an embodiment, the camera cover 2533 may include a camera cover body 2533a, a second protrusion 2533b, a camera cover protruding surface 2533c, a horizontal portion 2533d, and a connecting member 2533e.

According to an embodiment, the camera cover body 2533a may be disposed in the first direction (e.g., the -Z-axis direction) of the camera bracket 2532 to absorb an external impact transferred to the display panel 2392, and a second protrusion 2533b and a horizontal portion 2533d may be formed on the camera cover body 2533a.

According to an embodiment, the second protrusion 2533b may be a portion of the camera cover 2533 protruding from the camera cover body 2533a toward the light-emitting module bracket 2552 in the second direction (e.g., the +Z-axis direction).

According to an embodiment, the second protrusion 2533b may protrude in the second direction (e.g., the +Z-axis direction) at the position corresponding to the light-emitting module bracket protrusion 2552b, thereby more effectively preventing/blocking/reducing noise (e.g., light leakage) of the camera 2531 than when only the light-emitting module bracket protrusion 2552b is formed.

For example, when the second protrusion 2533b protrudes in the second direction (e.g., the +Z-axis direction), the second protrusion2533b is disposed on the path of light emitted from the light-emitting diode 2551 to more effectively prevent/reduce noise (e.g., light leakage) of the camera 2531.

According to an embodiment, the example embodiment of FIGS. 8 and 9 is an embodiment in which the second protrusion 2533b is excluded, and the example embodiment of FIG. 12 in which the second protrusion 2533b protrudes in the second direction (e.g., the +Z-axis direction) may more effectively prevent/reduce noise (e.g., light leakage) of the camera 2531 than the example embodiment of FIGS. 8 and 9.

According to an embodiment, as described above, the second protrusion 2533b may be configured to contact the elastic member 257.

According to an embodiment, the second protrusion 2533b may include a first side surface facing the camera module 253 and a second side surface facing the light-emitting module 255. Further, the first side surface may have a first height h1, and the second side surface may have a second height h2 longer in the first direction (e.g., the -Z-axis direction) than the first height h1.

An example is described in which the first height h1 of the first side surface is shorter in the first direction (e.g., the -Z-axis direction) than the second height h2 of the second side surface, but the disclosure is not limited thereto. The heights of the first side surface and the second side surface may be the same according to the design specifications of the electronic device.

According to an embodiment, the display 239 (e.g., the sub display 239 of FIG. 3) may include a second opening O2 formed at the position corresponding to at least a portion of the camera module 253 and a third opening O3 formed at the position corresponding to at least a portion of the light-emitting module 255.

According to an embodiment, the second opening O2 and the third opening O3 may refer, for example, to empty spaces formed in the display 239 (e.g., the sub display 239 of FIG. 3). According to an embodiment, the second opening O2 and the third opening O3 may refer, for example, to empty spaces formed in the display panel 2392.

According to an embodiment, the second opening O2 may be disposed in the first direction (e.g., the -Z-axis direction) of at least a portion of the camera module 253 so that the camera module 253 may receive light from the outside, and the third opening O3 may be disposed in the first direction (e.g., the -Z-axis direction) of at least a portion of the light-emitting module 255 so that the light-emitting module 255 may transfer light to the outside.

According to an embodiment, as the display panel 2392 is formed according to the HID structure forming the second opening O2 and the third opening O3 in the display panel 2392, the display 239 (e.g., the sub display 239 of FIG. 3) may be formed on the rear surface of the electronic device more widely.

As the second opening O2 and the third opening O3 are formed in the display panel 2392, the durability of the display panel 2392 may decrease, and thus the example embodiments of the disclosure may be required.

The electronic device having the HID structure in which the second opening O2 and the third opening O3 are formed is described as an example, but the disclosure is not limited thereto. The example embodiments of the disclosure may be applied to the rear surface of the bar-type electronic device or to an electronic device having a structure other than the HID structure.

According to an embodiment, the second protrusion 2533b may be positioned between the second opening O2 and the third opening O3 when viewed in the first direction (e.g., the -Z-axis direction), and the light-emitting module bracket protrusion 2552b may also be positioned between the second opening O2 and the third opening O3 when viewed in the first direction (e.g., the -Z-axis direction).

According to an embodiment, the camera cover protruding surface 2533c may refer to one surface disposed in the second direction (e.g., the +Z-axis direction) of the second protrusion 2533b. The camera cover protruding surface 2533c may be configured to face the light-emitting module bracket protruding surface 2552c.

According to an embodiment, the camera cover protruding surface 2533c may be spaced apart further than the upper surface 2551a of the light-emitting diode 2551 in the first direction (e.g., the -Z-axis direction) when viewed in the third direction (e.g., the Y-axis direction) perpendicular to the first direction (e.g., the -Z-axis direction).

An example is described in which the camera cover protruding surface 2533c is spaced apart in the first direction (e.g., the -Z-axis direction) further than the upper surface 2551a of the light-emitting diode 2551, but the disclosure is not limited thereto. When viewed in the third direction (e.g., the Y-axis direction), it may be spaced apart in the second direction (e.g., the +Z-axis direction) further than the upper surface 2551a of the light-emitting diode 2551.

According to an embodiment, the horizontal portion 2533d may extend toward the light-emitting module 255 in a direction substantially perpendicular to the second protrusion 2533b and may be configured to contact at least a portion of the transparent member 2553.

According to an embodiment, as the camera cover 2533 surrounds the transparent member 2553 in a direction substantially perpendicular to the second protrusion 2533b through the horizontal portion 2533d, the transparent member 2553 and the display panel 2392 may be prevented/blocked from contacting each other.

As the mounting space of the transparent member 2553 is at least partially limited through the camera cover 2533, the thickness of the electronic device in the first direction (e.g., the -Z-axis direction) may be decreased.

An example is described in which the horizontal portion 2533d is included, but the disclosure is not limited thereto. The horizontal portion 2533d may be excluded. When the horizontal portion 2533d is excluded, the camera cover 2533 may be configured not to contact the transparent member 2553.

According to an embodiment, the camera cover 2533 may further include a first opening O1 formed by the horizontal portion 2533d.

According to an embodiment, the first opening O1 may refer, for example, to an empty space surrounded by the second protrusion 2533b and/or the horizontal portion 2533d of the camera cover 2533, and a transparent member 2553 may be further disposed in the first opening O1.

According to an embodiment, the connecting member 2533e may be connected to the horizontal portion 2533d of the camera cover 2533 in the first direction (e.g., the -Z-axis direction), and may be connected to the transparent member 2553 in the second direction (e.g., the +Z-axis direction). The camera cover 2533 and the transparent member 2553 may be connected through the connecting member 2533e.

As the transparent member 2553 is disposed to be connected to the camera cover 2533, the transparent member 2553 may be formed to be spaced apart from the printed circuit board disposed on the light-emitting module bracket 2552, and thus, it is not electrically connected to the printed circuit board, so that when the transparent member 2553 is designed, it may be designed with materials with various physical properties (characteristics or properties that react to external conditions).

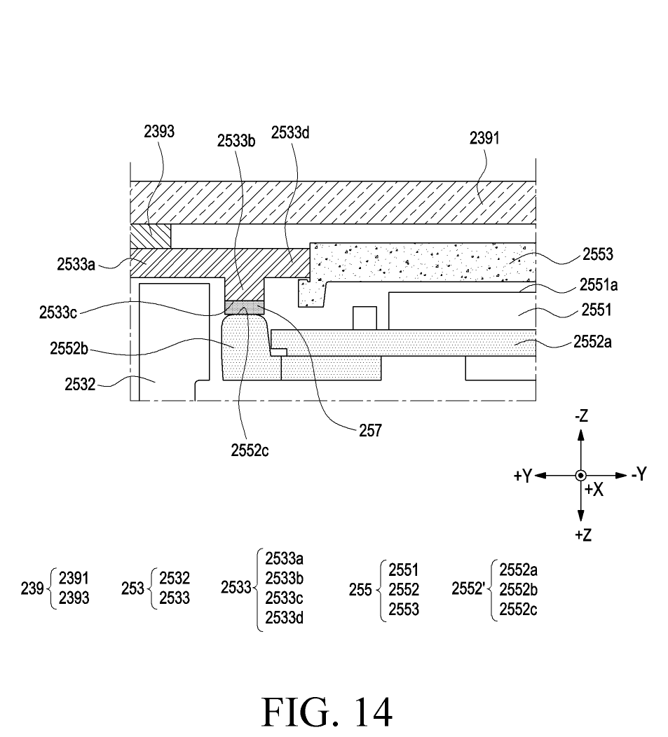

FIG. 13 is a perspective view illustrating a portion of an electronic device according to various embodiments. FIG. 14 is a cross-sectional view illustrating a camera module, a light-emitting module, and a display panel of an electronic device according to various embodiments.

The example embodiment of FIGS. 13 and 14 may be combined with the example embodiments of FIGS. 1 to 12 and/or 15-17.

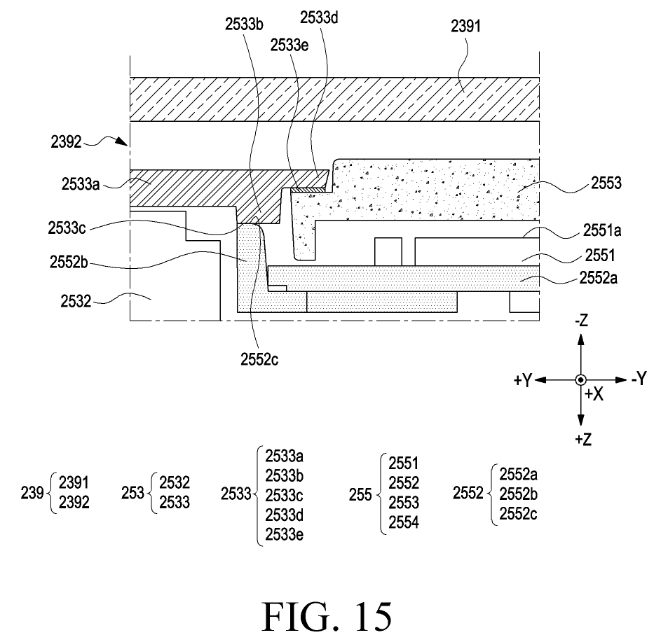

Some or all of the elements described with reference to FIGS. 13 and 14 may be the same as those described with reference to FIGS. 1-12. Some or all of the components described with reference to FIGS. 13 and 14 may be the same as those described with reference to FIGS. 15-17.

According to an embodiment, in the example embodiment of FIG. 12, the display panel (e.g., the display panel 2392 of FIG. 12) disposed between the window 2391 and the camera cover 2533 may be excluded.

According to an embodiment, as the display panel (e.g., the display panel 2392 of FIG. 12) is excluded between the window 2391 and the camera cover 2533, the length of the electronic device in the first direction (e.g., the -Z-axis direction) may be decreased.

A supporting member 2393 for supporting the window 2391 may be further disposed between the window 2391 and the camera cover 2533, and the length of the supporting member 2393 in the first direction (e.g., the -Z-axis direction) may be shorter than the length of the display panel (e.g., the display panel 2392 of FIG. 12) in the first direction (e.g., the -Z-axis direction).

According to an embodiment of FIG. 12, since the camera cover 2533 includes the second protrusion 2533b protruding toward the light-emitting module bracket 2552 and the horizontal portion 2533d extending toward the transparent member 2553, it is possible to effectively prevent and/or reduce the transmission of light emitted from the light-emitting diode 2551 to the camera module 253.

Since the camera cover 2533 includes the second protrusion 2533b protruding toward the light-emitting module bracket 2552 and the horizontal portion 2533d extending toward the transparent member 2553 as in the example embodiment of FIG. 12, the durability of the display 239 (e.g., the sub display 239 of FIG. 3) and the heat dissipation issue due to the light-emitting module 255 may also be enhanced.

As the gap between the camera cover 2533 and the window 2391 is decreased, and the supporting member 2393 is disposed between the camera cover 2533 and the window 239, the durability of the display 239 (e.g., the sub display 239 of FIG. 3) and the heat dissipation issue due to the light-emitting module 255 may be enhanced more effectively.

An example is described in which an additional supporting member 2393 is disposed between the window 2391 and the camera cover 2533, but the disclosure is not limited thereto. For example, the window 2391 and the camera cover 2533 may be configured to face each other without the additional supporting member 2393 between the window 2391 and the camera cover 2533 and, in such a case, a larger mounting space may be secured in the height direction (e.g., the first direction (e.g., the Z-axis direction)) of the electronic device than when the supporting member 2393 is disposed.

FIG. 15 is a cross-sectional view illustrating a camera module, a light-emitting module, and a display panel of an electronic device according to various embodiments.

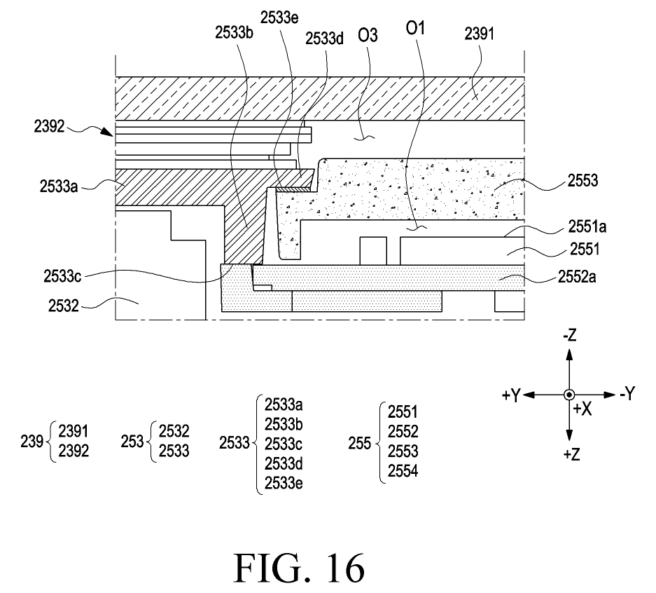

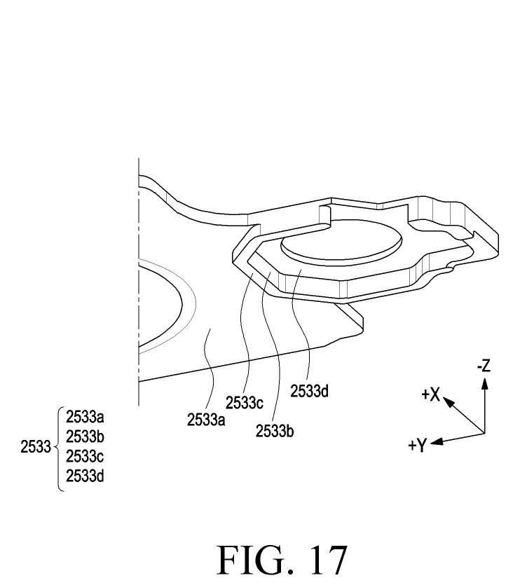

The example embodiment of FIG. 15 may be combined with the example embodiments of FIGS. 1-14 and/or FIGS. 16-17.

Some or all of the components described with reference to FIG. 15 may be the same as those described with reference to FIGS. 1-14. Some or all of the components described with reference to FIG. 15 may be the same as those described with reference to FIGS. 16 and 17. According to the example embodiment of FIG. 12, an elastic member (e.g., the elastic member 257 of FIG. 12) disposed between the camera cover 2533 and the light-emitting module bracket 2552 may be excluded.

According to an embodiment, even when the elastic member (e.g., the elastic member 257 of FIG. 12) is excluded, as in an embodiment of FIG. 12, since the camera cover 2533 includes the second protrusion 2533b protruding toward the light-emitting module bracket 2552 and the horizontal portion 2533d extending toward the transparent member 2553, it is possible to effectively prevent and/or reduce the transmission of light emitted from the light-emitting diode 2551 to the camera module 253.

According to an embodiment, when the elastic member (e.g., the elastic member 257 of FIG. 12) is excluded, the light emitted from the light-emitting diode 2551 may be effectively prevented/reduced from being transferred to the camera module 253, and the structure of the electronic device may be simplified to obtain a cost saving effect.

Since the volume of the camera cover 2533 is increased compared to the example embodiment of FIGS. 8 and 9, the heat generated by the light-emitting module 255 may be effectively dispersed even when the elastic member (e.g., the elastic member 257 of FIG. 12) is excluded.

An example is described in which the camera cover protruding surface 2533c and the light-emitting module bracket protruding surface 2552c contact each other, but the disclosure is not limited thereto. The camera cover protruding surface 2533c and the light-emitting module bracket protruding surface 2552c may be formed to be spaced apart while facing each other.

FIG. 16 is a cross-sectional view illustrating a camera module, a light-emitting module, and a display panel of an electronic device according to various embodiments.

The example embodiment of FIG. 16 may be combined with the example embodiments of FIGS. 1-15 and/or 17.

Some or all of the elements described with reference to FIG. 16 may be the same as those described with reference to FIGS. 1-15. Some or all of the components described with reference to FIG. 16 may be the same as all or some of the components described with reference to FIG. 17.

According to an embodiment, the light-emitting module bracket protrusion 2552b and the light-emitting module bracket protruding surface 2552c of the light-emitting module bracket 2552 may be excluded from the example embodiment of FIG. 16.

According to an embodiment, the light-emitting module bracket 2552 may be configured to support the light-emitting diode 2551 and the transparent member 2553 and may be a component that includes only the flat light-emitting module bracket body 2552a substantially parallel to the rear surface of the electronic device.

According to an embodiment, the second protrusion 2533b may extend in the second direction (e.g., the +Z-axis direction) toward the light-emitting module bracket body 2552a. Further, the second protrusion 2533b extending in the second direction (e.g., the +Z-axis direction) may contact the light-emitting module bracket body 2552a.

An example is described in which the elastic member (e.g., the elastic member 257 of FIG. 12) is excluded between the light-emitting module bracket body 2552a and the second protrusion 2533b, but the disclosure is not limited. The elastic member (e.g., the elastic member 257 of FIG. 12) may be additionally disposed between the light-emitting module bracket body 2552a and the second protrusion 2533b.

According to an embodiment, when the light-emitting module bracket protrusion 2552b and the light-emitting module bracket protruding surface 2552c are excluded, the light emitted from the light-emitting diode 2551 may be effectively prevented/reduced from being transferred to the camera module 253, and the structure of the light-emitting module bracket 2552 may be simplified, thereby reducing costs.

The second protrusion 2533b may extend longer in the second direction (e.g., the +Z-axis direction) toward the light-emitting module bracket body 2552a, so that the volume of the camera cover 2533 may be increased compared to the example embodiment of FIGS. 8 and 9, and may effectively disperse the heat generated from the light-emitting module 255.

FIG. 17 is a perspective view illustrating a camera cover of an electronic device according to various embodiments.

The example embodiment of FIG. 17 may be combined with the example embodiments of FIGS. 1-16.

Some or all of the components described with reference to FIG. 17 may be the same as those described with reference to FIGS. 1-16.

According to an embodiment, the horizontal portion 2533d may be configured to form the above-described first opening (e.g., the first opening O1 of FIG. 12).

According to an embodiment, the second protrusion 2533b may be disposed between the camera cover body 2533a and the above-described first opening (e.g., the first opening O1 of FIG. 12), and may be formed along the edge of the horizontal portion 2533d.

According to an embodiment, the second protrusion 2533b may extend in the second direction (e.g., the +Z-axis direction) from at least a portion of the edge of the horizontal portion 2533d.

According to an embodiment, an example is described in which the second protrusion 2533b extends in the second direction (e.g., the +Z-axis direction) only on at least a portion of the edge of the horizontal portion 2533d, but the disclosure is not limited thereto.

For example, it may be a component formed to extend in the second direction (e.g., the +Z-axis direction) in the whole area of the horizontal portion 2533d, and when the volume of the camera cover 2533 increases, the rigidity of the electronic device may be increased, and heat generated by the light-emitting module 255 may be effectively dispersed.

To mount other electronic components, the second protrusion 2533b may be disposed between the camera cover body 2533a and the above-described first opening (e.g., the first opening O1 of FIG. 12), but may be excluded from at least a portion of the edge of the horizontal portion 2533d.

The disclosure relates to an electronic device. According to an embodiment of the disclosure, an electronic device 101 may comprise a housing 201, a display 239 accommodated in the housing such that a screen is visible in a first direction toward an outside of the electronic device, a light-emitting module 255 at least partially disposed under the display 239 and including a light-emitting module bracket 2552 and a light-emitting diode (LED) 2551 disposed on the light-emitting module bracket 2552 and configured to emit light in the first direction toward the outside of the electronic device 101, and a camera module 253 at least partially disposed under the display 239 and disposed adjacent to the light-emitting module 255 in a direction perpendicular to the first direction, and including a camera bracket, one or more lenses at least partially accommodated in the camera bracket 2532, and a camera cover 2533 at least partially disposed under the display 239 and at least partially surrounding the camera bracket 2532. The camera cover 2533 may include a second protrusion 2533b protruding toward the light-emitting module bracket 2552 in the second direction opposite to the first direction.

According to an embodiment, in the electronic device, the light-emitting module bracket 2552 may comprise a light-emitting module bracket protrusion 2552b protruding toward the camera cover 2533.

According to an embodiment, in the electronic device, the second protrusion 2533b may protrude in the second direction at a position corresponding to the light-emitting module bracket protrusion 2552b.

According to an embodiment, in the electronic device, the light-emitting module bracket protrusion 2552b and the second protrusion 2533b may be formed to be spaced apart from each other.

According to an embodiment, the electronic device may further comprise an elastic member 257 disposed between the light-emitting module bracket protrusion 2552b and the second protrusion 2533b, and connected to the light-emitting module bracket protrusion 2552b or the second protrusion 2533b.

According to an embodiment, in the electronic device, the elastic member 257 may be connected to the light-emitting module bracket protrusion 2552b and the second protrusion 2533b.

According to an embodiment, in the electronic device, when viewed in a third direction perpendicular to the first direction, a camera cover protruding surface 2533c of the second protrusion 2533b may be spaced apart in the first direction from an upper surface 2551a of the light-emitting diode 2551.

According to an embodiment, in the electronic device, when viewed in a third direction perpendicular to the first direction, a camera cover protruding surface 2533c of the second protrusion 2533b may be spaced apart in the second direction from an upper surface 2551a of the light-emitting diode 2551.

According to an embodiment, in the electronic device, the light-emitting module 255 may be configured to overlap the light-emitting diode 2551 when viewed in the first direction and comprise a transparent member 2553 disposed in the first direction above the light-emitting module bracket 2552.

According to an embodiment, in the electronic device, the camera cover 2533 may further comprise a horizontal portion 2533d extending toward the light-emitting module 255 in a direction substantially perpendicular to the second protrusion 2533b, and the horizontal portion 2533d is in contact with at least a portion of the transparent member 2553.

According to an embodiment, in the electronic device, the camera cover 2533 may comprise a first opening O1 formed by the horizontal portion 2533d, and a portion of the transparent member 2553 may protrude through the first opening O1 in the first direction.

According to an embodiment, in the electronic device, the second protrusion 2533b may comprise a first side facing the camera module 253 and a second side facing the light-emitting module 255, and the first side may have a first height h1, and the second side may have a second height h2 greater than the first height h1 in the first direction.

According to an embodiment, in the electronic device, the second protrusion 2533b may comprise a first side facing the camera module 253 and a second side facing the light-emitting module 255, and the first side and the second side may have the same height.

According to an embodiment, the electronic device may further comprise a display 239 accommodated in the housing such that a screen is visible in the first direction toward the outside of the electronic device. The display 239 may comprise a second opening O2 formed at a position corresponding to at least a portion of the camera module 253, and a third opening O3 formed at a position corresponding to at least a portion of the light-emitting module 255. The second protrusion 2533b may, when viewed in the first direction, be located between the second opening O2 and the third opening O3.

According to an embodiment, in the electronic device, the light-emitting module bracket protrusion 2552b may, when viewed in the first direction, be located between the second opening O2 and the third opening O3.

The disclosure relates to an electronic device. According to an embodiment of the disclosure, a foldable electronic device 200 may comprise a foldable housing 201 including a first housing 210 and a second housing 220 rotatably disposed relative to the first housing 210, a hinge structure 270 connected to the first housing 210 and the second housing 220, a sub display 239 disposed in the first housing 210 and configured to face the first direction, a flexible display 230 disposed in the foldable housing 201 and configured to face a second direction opposite to a first direction, a light-emitting module 255 at least partially disposed in the second direction of the sub display 239, including a light-emitting module bracket 2552 and a light-emitting diode (LED) 2551 disposed in the first direction of the light-emitting module bracket 2552. The light-emitting diode 2551 may be disposed to face the first direction and may be configured to emit light to an outside of the foldable electronic device 200, and a camera module 253 at least partially disposed in the second direction of the sub display 239 and disposed adjacent to the light-emitting module 255 in a third direction perpendicular to the first direction, and including a camera bracket 2532, one or more lenses at least partially accommodated in the camera bracket 2532, and a camera cover 2533 at least partially disposed in the second direction of the sub display 239 and disposed in the first direction of the camera bracket 2532. The camera cover 2533 may include a second protrusion 2533b protruding toward the light-emitting module bracket 2552 in the second direction.

According to an embodiment, in the foldable electronic device, the light-emitting module bracket 2552 may comprise a light-emitting module bracket protrusion 2552b protruding toward the camera cover 2533, and the second protrusion 2533b may protrude in the second direction at a position corresponding to the light-emitting module bracket protrusion 2552b.

According to an embodiment, the foldable electronic device may further comprise an elastic member 257 disposed between the light-emitting module bracket protrusion 2552b and the second protrusion 2533b, and connected to the light-emitting module bracket protrusion 2552b or the second protrusion 2533b.

According to an embodiment, in the foldable electronic device, when viewed in a third direction perpendicular to the first direction, a camera cover protruding surface 2533c of the second protrusion 2533b may be spaced apart in the first direction from an upper surface 2551a of the light-emitting diode 2551.

According to an embodiment, in the foldable electronic device, the light-emitting module 255 may be configured to overlap the light-emitting diode 2551 when viewed in the first direction and may comprise a transparent member 2553 disposed in the first direction above the light-emitting module bracket 2552, and the camera cover 2533 may further comprise a horizontal portion 2533d extending toward the light-emitting module 255 in a direction substantially perpendicular to the second protrusion 2533b, and the horizontal portion 2533d is in contact with at least a portion of the transparent member 2553.

The disclosure relates to an electronic device. According to an embodiment of the disclosure, an electronic device 101 may comprise a housing 201 configured to form an exterior of the electronic device, a camera module 253 at least partially disposed inside the housing, the camera module comprising a camera bracket 2532, at least one lens accommodated in the camera bracket 2532, and a camera cover 2533 covering the camera bracket 2532, and a light-emitting module 255 disposed around the camera module 253, the light-emitting module comprising a light-emitting module bracket 2552 and a light-emitting diode (LED) 2551 disposed in the light-emitting module bracket 2552. The camera cover 2533 may include a first protrusion 2533f protruding in a first direction toward an outside from one surface of the housing and a second protrusion 2533b spaced apart from the first protrusion 2533f and protruding in a second direction opposite to the first direction. The second protrusion 2533b may be formed to at least partially surround the light-emitting diode 2551.According to an embodiment, it is possible to prevent and/or reduce light generated from the light-emitting module from being transferred to the camera module by including the second protrusion formed to extend toward the light-emitting module in the camera cover. This may enhance the quality of the image captured through the camera module.

According to an embodiment, there may be provided an electronic device that has an opening in the light-emitting module and the camera module and includes a partition wall structure (e.g., the second protrusion) that does not impact the sub display although the sub display is disposed adjacent to the opening.

Effects obtainable from the disclosure are not limited to the above-mentioned effects, and other effects not mentioned may be apparent to one of ordinary skill in the art from the description.

It is apparent to one of ordinary skill in the art that the electronic device cover 101 described above with reference to various example embodiments of the disclosure as described above are not limited to the above-described embodiments and those shown in the drawings, and various changes, modifications, or alterations may be made thereto without departing from the scope of the disclosure. It will also be understood than any of the example embodiment(s) described herein may be used in conjunction with any other embodiment(s) described herein.

What is claimed is:

1. An electronic device comprising:
a housing forming an exterior of the electronic device;
a camera module at least partially disposed inside the housing, the camera module comprising a camera bracket, at least one lens accommodated in the camera bracket, and a camera cover covering the camera bracket; and
a light-emitting module disposed around the camera module, the light-emitting module comprising a light-emitting module bracket and a light-emitting diode (LED) disposed in the light-emitting module bracket,
wherein the camera cover comprises a first protrusion, protruding in a first direction perpendicular to one surface of the housing and exposed to the outside through an opening formed in the one surface of the housing, and a second protrusion spaced apart from the first protrusion and protruding in a second direction opposite to the first direction, wherein the second protrusion at least partially surrounds the light-emitting diode.

2. The electronic device of claim 1,
wherein the light-emitting module bracket comprises a light-emitting module bracket protrusion protruding in the first direction toward the camera cover.

3. The electronic device of claim 1,
wherein the second protrusion protrudes in the second direction at a position corresponding to the light-emitting module bracket protrusion.

4. The electronic device of claim 1,
wherein the light-emitting module bracket protrusion and the second protrusion are spaced apart from each other.

5. The electronic device of claim 1, further comprising
an elastic member comprising an elastic material disposed between the light-emitting module bracket protrusion and the second protrusion, and connected to the light-emitting module bracket protrusion or the second protrusion.

6. The electronic device of claim 4,
wherein the elastic member is connected to the light-emitting module bracket protrusion and the second protrusion.

7. The electronic device of claim 1,
wherein when viewed in a third direction perpendicular to the first direction, a camera cover protruding surface of the second protrusion is spaced apart in the first direction from an upper surface of the light-emitting diode.

8. The electronic device of claim 1,
wherein when viewed in a third direction perpendicular to the first direction, a camera cover protruding surface of the second protrusion is spaced apart in the second direction from an upper surface of the light-emitting diode.

9. The electronic device of claim 1,
wherein the light-emitting module overlaps the light-emitting diode when viewed in the first direction and comprises a transparent member comprising a transparent material disposed in the first direction above the light-emitting module bracket.

10. The electronic device of claim 1,
wherein the camera cover further comprises a horizontal portion extending toward the light-emitting module in a direction substantially perpendicular to the second protrusion, and the horizontal portion is in contact with at least a portion of the transparent member.

11. The electronic device of claim 9,
wherein the camera cover comprises a first opening formed by the horizontal portion, and
a portion of the transparent member protrudes through the first opening in the first direction.

12. The electronic device of claim 1,
wherein the second protrusion comprises a first side facing the camera module and a second side facing the light-emitting module, and
the first side has a first height, and the second side has a second height greater than the first height in the first direction.

13. The electronic device of claim 1,
wherein the second protrusion comprises a first side facing the camera module and a second side facing the light-emitting module, and
the first side and the second side have the same height.

14. The electronic device of claim 1, further comprising
a display accommodated in the housing such that a screen is visible in the first direction toward the outside of the electronic device,
wherein the display comprises:
a second opening formed at a position corresponding to at least a portion of the camera module; and
a third opening formed at a position corresponding to at least a portion of the light-emitting module,
wherein the second protrusion, when viewed in the first direction, is located between the second opening and the third opening.

15. The electronic device of claim 14,
wherein the light-emitting module bracket protrusion, when viewed in the first direction, is located between the second opening and the third opening.

16. A foldable electronic device, comprising:
a foldable housing including a first housing and a second housing rotatably disposed relative to the first housing;
a hinge structure comprising a hinge connected to the first housing and the second housing;
a sub display disposed in the first housing and facing a first direction;
a flexible display disposed in the foldable housing and facing a second direction opposite to the first direction;
a light-emitting module at least partially disposed in the second direction of the sub display, including a light-emitting module bracket and a light-emitting diode (LED) disposed in the first direction of the light-emitting module bracket, wherein the light-emitting diode is disposed to face the first direction and is configured to emit light to an outside of the foldable electronic device; and
a camera module at least partially disposed in the second direction of the sub display and disposed adjacent to the light-emitting module in a third direction perpendicular to the first direction, and including a camera bracket, one or more lenses at least partially accommodated in the camera bracket, and a camera cover at least partially disposed in the second direction of the sub display and disposed in the first direction of the camera bracket, and
wherein the camera cover includes a second protrusion protruding toward the light-emitting module bracket in the second direction.

17. The foldable electronic device of claim 16,
wherein the light-emitting module bracket comprises a light-emitting module bracket protrusion protruding toward the camera cover , and
wherein the second protrusion protrudes in the second direction at a position corresponding to the light-emitting module bracket protrusion.

18. The foldable electronic device of claim 16, further comprising
an elastic member comprising an elastic material disposed between the light-emitting module bracket protrusion and the second protrusion, and connected to the light-emitting module bracket protrusion or the second protrusion.

19. The foldable electronic device of claim 16,
wherein when viewed in a third direction perpendicular to the first direction, a camera cover protruding surface of the second protrusion is spaced apart in the first direction from an upper surface of the light-emitting diode.

20. The foldable electronic device of claim 16,
wherein the light-emitting module is configured to overlap the light-emitting diode when viewed in the first direction and comprises a transparent member comprising a transparent material disposed in the first direction above the light-emitting module bracket, and
wherein the camera cover further comprises a horizontal portion extending toward the light-emitting module in a direction substantially perpendicular to the second protrusion, and the horizontal portion is in contact with at least a portion of the transparent member.
